(19) United States
(12) Patent Application Publication
(10) Pub. No.: US 2007/0288995 A1
(43) Pub. Date: Dec. 13, 2007

(54) Authentication system for authenticating based on measured distance and exchanged identifier

(75) Inventors: Takahide Terada, Nishitokyo (JP); Akira Maeki, Kokubunji (JP); Masayuki Miyazaki, Tokyo (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/785,377

(22) Filed: Apr. 17, 2007

(30) Foreign Application Priority Data
Jun. 12, 2006 (JP) 2006-162369

(51) Int. Cl. H04L 9/32

(52) U.S. Cl. 726/2

(57) ABSTRACT

To provide compact, low power consumption authenticating devices and authentication target device, and capable of simultaneous communication for acquiring an identifier, and acquiring distance information. Provided is an authentication system comprising an authenticating device and an authentication target device which communicates by using ultra wide band impulse signals, wherein the authentication system measures the distance between the authenticating device and the authentication target device by using ultra wide band impulse signal to exchange identification information of the authenticating device and identification information of the authentication target device between each device, wherein the authenticating device authenticates the authentication target device based on a combination of the measured distance between the authenticating device and the authentication target device, and the exchanged identification information of the authentication target device, and wherein the authenticating device generate control signal to control a control target based on the authentication results.

### CLAIM OF PRIORITY

The present application claims priority from Japanese patent application JP 2006-162369 filed on Jun. 12, 2006, the content of which is hereby incorporated by reference into this application.

### FIELD OF THE INVENTION

This invention relates to an authentication system and relates in particular to an authentication system utilizing distance information in the authentication conditions.

### BACKGROUND OF THE INVENTION

In wireless network systems such as sensor network systems, if the wireless communication distance is long (for example, 30 meters) when using relay stations or base stations as readers (authenticating devices), then all tags (authentication target devices) within that communication range are authenticated. In the case of entry/exit control systems access for example, all doors within 30 meters of the target door are also unlocked which is a problem in terms of security.

Methods were therefore proposed to improve security by limiting the communication distance during authentication to a short distance (refer to JP 2005-159690 A and JP 2005-109720 A)

On the other hand there are many types of authentication target devices (tags) so that the optimum value for authentication range differs according to the item to be authenticated. If the authentication range was set to one value when using the same reader and tag, then some items for authentication will be in correct range while other items for authentication will be outside that range. The problems therefore occurred that security was poor, the system was inconvenient to use, and would not operate correctly.

A method was therefore proposed in which authentication target device detect their own position and send that position information to the authenticating device during authentication to eliminate the hazard of unauthorized users passing the authentication process by pretending to be another person. More specifically, a GPS, an acceleration sensor and a wireless network area are used for position detection (refer to JP 1998-56449 A). If the method disclosed in JP 1998-056449 A is used to resolve the aforementioned problems then a correct range can be set to successfully authenticate each authentication target device. During detection the position of the authentication target device is detected using the previously described position detection technique, and that position information sent along with an identifier to the authenticating device. The authenticating device then authenticates the tag based on the identifier and position information.

A wireless communication method utilizing ultra wide band (UWB) was proposed as technology (position and/or distance measurement) for measuring a mobile unit position and/or the distance to the mobile unit position (refer to JP 2004-258009A.) The UWB impulse radio (UWB-IR) can measure distance with high accuracy. In other words, when measuring the distance between two UWB communication devices A and B, the device A first of all sends a UWB signal 1, the device B receives this UWB signal 1 and returns a UWB signal 2. The device B internal delay time from the time signal 1 is sent to the time the signal 2 is received to calculate the signal propagation time. The signal propagates at the speed of light so that multiplying the propagation time by the speed of light allows finding the propagation distance.

The JP 2005-128965A discloses technology relating to applying UWB to authenticating information terminals. However, JP 2005-128965A discloses only “authentication” technology for granting access rights.

### SUMMARY OF THE INVENTION

The authentication target device to be authenticated is carried by people or is attached to objects and so is preferably a small device powered by a battery. So except for authentication components it is essential to eliminate as much equipment as possible. However if utilizing GPS such as in the technology previously described for JP 1998-56449 A, then a receiver is required for receiving GPS signals from a GPS satellite. Also, if using an acceleration sensor, then a device to detect the acceleration is required. Therefore providing position detection equipment interferes with making the authentication target device a compact device with low power consumption.

Though JP 1998-56449 A discloses means such as GPS, acceleration sensors or wireless network areas for detecting a position, there is no description whatsoever of position detection by UWB. In other words, the JP 1998-56449 A discloses no technology for detecting the position of the authentication target device via a UWB system.

The “authentication” as disclosed in JP 2005-128965 A is different from the strict view of “authentication” focusing solely on an identifier. Even if the “authentication” in JP 2005-128965 A is interpreted as the wide meaning of “authentication”, there is absolutely no mention whatsoever of individual unique identifiers as objects for authentication, and establishing a link between information on the distance and the position of the object for authentication including that identifier, and a system for making authentications based on that relation.

For example, the JP 2005-128965A, a decision to grant or prohibit access is made based only on the distance from the server serving as the “authorizer”. Therefore, multiple objects within the same distance cannot be distinguished from each other. So all objects within the access “OK” distance are recognized as “Access-allowed objects”, while all objects within a distance where access is “Prohibited” are recognized as “Access-prohibited objects”. No password or ID are sent to objects recognized as “Access-prohibited objects”, while an ID and a password are sent to objects recognized as “Access-allowed objects”.

Namely, the technology disclosed in this document authorizes an object based only on the distance, and then grants or does not grant an ID based on those authentication results. This document in other words, essentially does not disclose technology linking the ID with distance. Moreover, authentication linking the distance and the ID is impossible due to the system configuration. In particular, use of an object ID in authentication that was already rejected during authentication is impossible.

This technology therefore had the problem of being unable to discriminate objects far away that the system want to grant access to, from objects the system does not want to grant access to unless close by. This technology merely discloses UWB as a technique for detecting the distance in systems that “make authentications based only on distance”. Namely, this technology only focuses on no other technical aspects of UWB other than the well known “capable of bearing and distance” aspect in the related art. Therefore UWB is likely to yield no effects other than the “capable of bearing and distance” aspect.

Evaluating combinations of the above described background art reveals the following. A simple combination of the technology disclosed in JP 1998-56449 A and the technology disclosed in JP 2004-258009A shows that the authentication target device utilizes UWB to detect its own position. In this case, signals must be sent and received at least two times in order to acquire the distance information.

More specifically, in the first transmission-reception signal (3-way handshake: send, receive and acknowledge) the authentication target device finds the distance, and in the second signal sends the distance results to the authenticating device. During the first signal the distance information is unknown even though the ID is already known. Distance information becomes known after sending and receiving of the first signal is completed. Only the authentication target device knows the distance at that time. The authenticating device therefore cannot obtain the distance information unless that distance information is sent to the authenticating device in the second transmission-reception signal. So in systems combining the technology of the background art, the authenticating device cannot acquire both the ID and the distance information in just one transmission-reception signal.

This invention therefore has the object of providing an authentication system including compact, low power consumption authenticating devices and authentication target devices, for acquiring position information on the authentication target device, setting an appropriate authenticating range for each authentication target device and each authenticating device, without requiring installation of special equipment other than for authentication.

A representative aspect of this invention is as follows. That is, there is provided an authentication system comprising an authenticating device and an authentication target device which communicates by using ultra wide band impulse signals, wherein the authentication system measures the distance between the authenticating device and the authentication target device by using ultra wide band impulse signal to exchange identification information of the authenticating device and identification information of the authentication target device between each device, wherein the authenticating device authenticates the authentication target device based on a combination of the measured distance between the authenticating device and the authentication target device, and the exchanged identification information of the authentication target device, and wherein the authenticating device generate control signal to control a control target based on the authentication results.

This invention provides compact, low power consumption authenticating devices and authentication target device, and capable of simultaneous communication for acquiring an identifier, and acquiring distance information.

### BRIEF DESCRIPTION OF THE DRAWINGS

The present invention can be appreciated by the description which follows in conjunction with the following figures, wherein:

FIG. 1 is a block diagram showing the configuration of the authentication system of the first embodiment of this invention;

FIG. 2 is a block diagram showing the configuration of the server of the first embodiment of this invention;

FIG. 3 is a block diagram showing a typical configuration of the base station of the first embodiment of this invention;

FIG. 4 is a block diagram showing the configuration of the reader and the tag of the first embodiment of this invention;

FIG. 5 shows an example of the authentication system applied to an entry/exit control system of the first embodiment of this invention;

FIG. 6 is a sequence chart for describing an example of the authentication sequence of the first embodiment of this invention;

FIG. 7 shows the signal waveform used in UWB-IR wireless communication of the first embodiment of this invention;

FIG. 8 is a sequence chart for describing an example of the authentication sequence when the tag is requesting authentication of the reader of the first embodiment of this invention;

FIG. 9 is a block diagram showing a typical configuration of the reader in the second embodiment of this invention;

FIG. 10 is a block diagram showing a typical configuration of the base station of the second embodiment of this invention;

FIG. 11 is a block diagram showing a typical configuration of the server of the second embodiment of this invention;

FIG. 12 shows an example of the authentication system applied to an entry/exit control system of the second embodiment of this invention;

FIG. 13 is a sequence chart for describing a typical authentication sequence of the second embodiment of this invention;

FIG. 14 is a block diagram showing a typical configuration for the reader comprising an antenna array of the second embodiment of this invention;

FIG. 15 shows an example of the second embodiment of this invention applied to control of room lighting of the second embodiment of this invention;

FIG. 16 show examples applied to a display device of the second embodiment of this invention;

FIG. 17 show examples applied to a display device of the second embodiment of this invention;

FIG. 18 is a block diagram showing the configuration of the server of the third embodiment of this invention;

FIG. 19 is a block diagram showing the configuration of the base station of the third embodiment of this invention;

FIG. 20 is drawings showing an example of the authentication system applied to an entry/exit control system of the third embodiment of this invention;

FIG. 21 is a sequence chart for describing an example of the authentication database setting sequence of the third embodiment of this invention;

FIG. 22 is a sequence chart for describing an example of the authentication sequence of the third embodiment of this invention;

FIG. 23 is a block diagram showing the configuration of the server of the fourth embodiment of this invention;

FIG. 24 is a block diagram showing the configuration of the base station of the fourth embodiment of this invention;

FIG. 25 shows an example of the authentication system applied to an entry/exit control system of the fourth embodiment of this invention;

FIG. 26 is a sequence chart for describing an example of the authentication sequence of the fourth embodiment of this invention;

FIG. 27 is a block diagram showing the configuration of the server of the fifth embodiment of this invention;

FIG. 28 shows an example of the authentication system applied to an entry/exit control system of the fifth embodiment of this invention;

FIG. 29 is a sequence chart for describing an example of the authentication sequence of the fifth embodiment of this invention;

FIG. 30 is a block diagram showing the configuration of the reader of the sixth embodiment of this invention;

FIG. 31 is a block diagram showing the configuration of the base station of the sixth embodiment of this invention;

FIG. 32 is a sequence chart for describing an example of the authentication sequence of the sixth embodiment of this invention; and

FIG. 33 is a block diagram showing the configuration of the receiving unit of the reader of the sixth embodiment of this invention.

### DETAILED DESCRIPTION OF THE PREFERRED EMBODIMENT

The preferred embodiments of this invention are described next while referring to the drawings. The embodiments described next are nothing more than examples for revealing the invention and the invention is not limited to these embodiments.

### First Embodiment

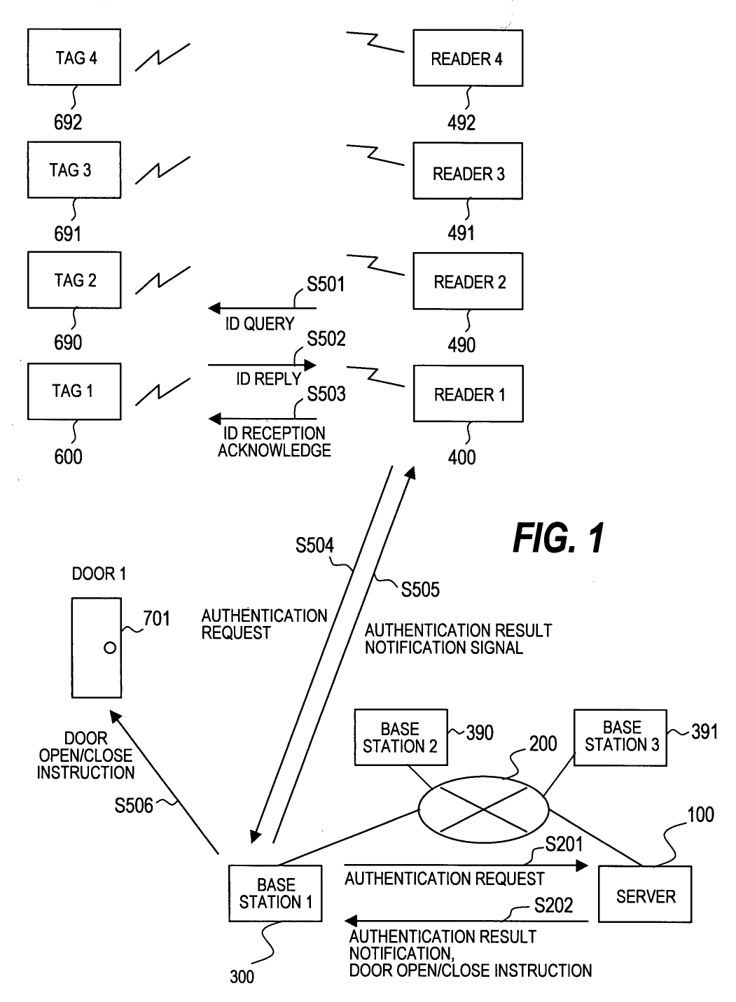

FIG. 1 is a block diagram showing the configuration of the authentication system of the first embodiment of this invention. The authentication system of the first embodiment comprises a server 100, a network 200, a base station 300, an authenticating device (reader) 400, an authentication target device (tag) 600, and a control object (door) 701. There is no restriction on the number of base stations, readers, tags and doors, and more than one may be installed. Therefore in the example in FIG. 1, besides the base station 300, there are a base station 390 and 391; besides the reader 400 there are readers 490, 491 and 492; and besides the tag 600 there are also a tag 690, 691 and 692.

The other base stations 390 and 391 may have the same configuration as the base station 300. The other readers 490, 491 and 492 may have the same configuration as the reader 400. Also, the other tags 690, 691 and 692 may each have the same configuration as the tag 600. A description of the base stations 390 and 391, the readers 490, 491 and 492, and the tags 690, 691 and 692 are therefore omitted except where there is necessary. If a description was omitted then the respective operation is the same as the base station 300, the reader 400 and the tag 600.

The reader 400 connects via radio (wireless) communication path to the tag 600, and after sending an ID query signal S501, receives an ID reply signal S502, and then sends an ID reception acknowledge signal S503.

The base station 300 connects via radio (wireless) communication path to the reader 400, receives an authentication request signal S504, and sends an authentication result notification signal S505. The base station 300 connects via radio (wireless) communication path to the door 701, and sends a door open/close instruction signal S506.

The server 100 connects over a network 200 to the base station 300, receives an authentication request signal S201, and sends an authentication result notification signal S202.

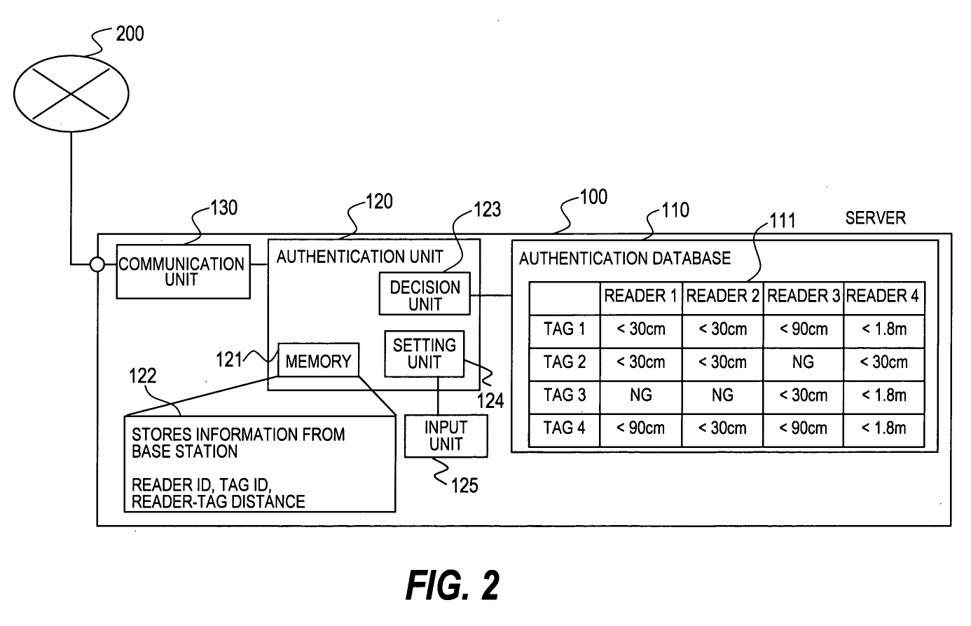

FIG. 2 is a block diagram showing the configuration of the server 100 of the first embodiment of this invention.

The server 100 comprises an authentication database 110, an authentication unit 120, an input unit 125, and a communication unit 130. The server 100 connects via the network 200 to the base station 300, receives the authentication request signal S201, and sends an authentication result notification signal S202.

The authentication unit 120 comprises a memory 121, a decision unit 123 and a setting unit 124. The memory 121 stores the information 122 acquired from the base station 300. For example, the reader ID, tag ID and the distances between the reader and the tag are stored in the memory 121.

The decision unit 123 and the setting unit 124 are implemented by a processor executing a stored program. More specifically, the decision unit 123 collates the information 122 stored in the memory 121 with the authentication data 111 stored in the authentication database 110, and decides to authenticate or not. The setting unit 124 sets the authentication data 111 based on the data input from the input unit 125. This authentication data 111 may also be set based on data sent from other devices over the network 200.

The input unit 125 comprises input devices such as a keyboard and/or a mouse, etc.

The communication unit 130 is an interface for sending and receiving data according to a specified protocol. If the network 200 for example is the Internet or an intranet, then the communication unit 130 is a network interface for sending and receiving data according to a TCP/IP protocol.

The authentication database 110 is stored in a nonvolatile storage (for example, a flash memory or hard disk drive). The distance information between the reader and the tag is bound with the reader ID and the tag ID and stored. As described later on, if the distance between the reader and the tag is smaller than the distance information stored in the authentication database 110 then the tag was successfully authenticated.

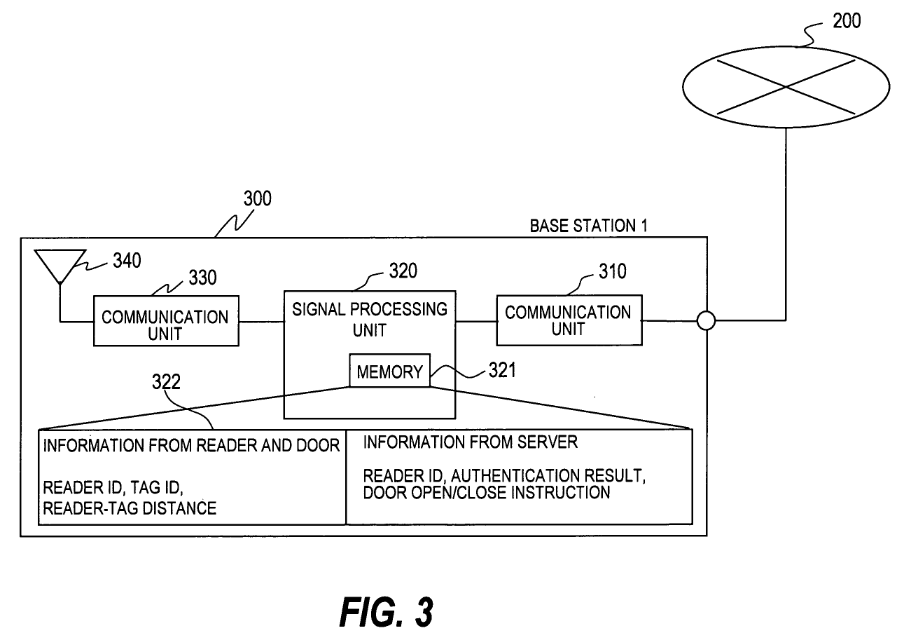

FIG. 3 is a block diagram showing a typical configuration of the base station 300 of the first embodiment of this invention.

The base station 300 comprises a network communication unit 310, a signal processing unit 320, a wireless communication unit 330 and an antenna 340.

The signal processing unit 320 is operated by executing a stored program executed by a processor. The signal processing unit 320 comprises a memory 321. The memory 321 stores the information acquired from the reader 400, and the information acquired from the server 100 via the network 200. The signal processing unit 320 sends the information 322 stored in the memory 321 to the server 100, the reader 400 and the door 701 when necessary.

The network communication unit 310 is an interface for sending and receiving data according to a specified protocol. If the network 200 for example is the Internet or an intranet, then the network communication unit 310 is a network interface that sends and receives data according to a TCP/IP protocol.

The wireless communication unit 330 comprises a transmitter and a receiver, and is an interface for sending and receiving data according to a specified wireless communication protocol.

Besides the reader 400 and the door 701, the base station 300 may be connected to and communicated with other devices such as the reader 490 and the door 702.

The base station 300 and the door 701 may be connected by a communication cable rather than by wireless communication. The door 701 may be connected to the network 200 via other devices without using the base station 300. The door 701 may comprises a TCP/IP interface, connecting directly to the network 200, and communicating with a server 100.

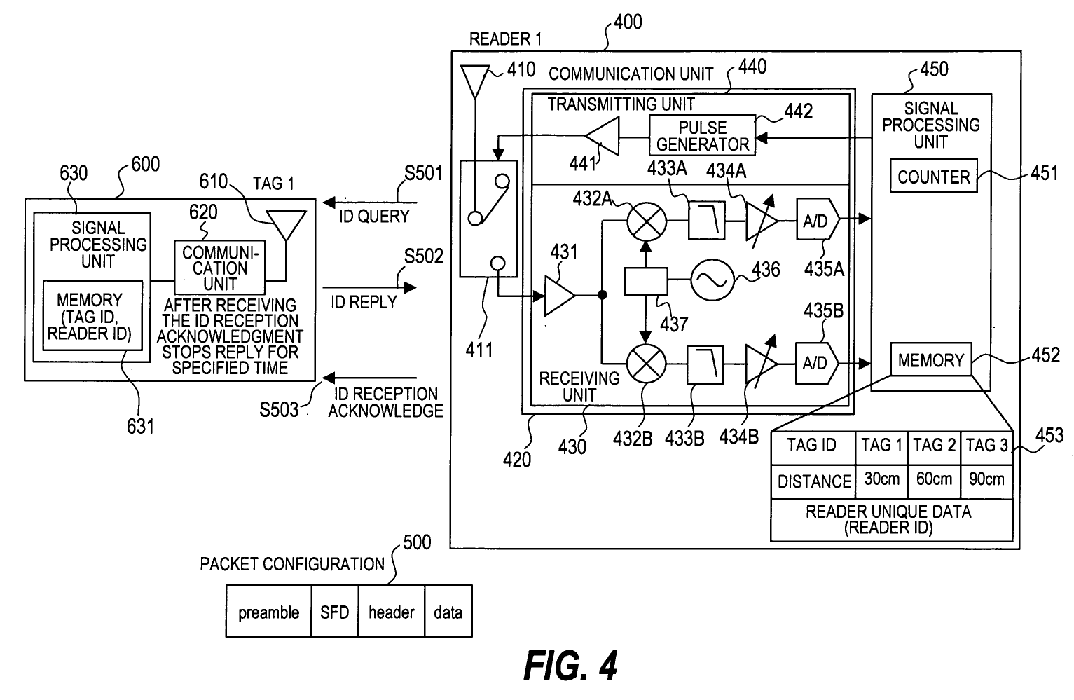

FIG. 4 is a block diagram showing the configuration of the reader 400 and the tag 600 of the first embodiment of this invention.

The reader 400 comprises an antenna 410, a switch 411, a wireless communication unit 420 and a signal processing unit 450.

The wireless communication unit 420 comprises a wireless receiving unit 430 and a wireless transmitting unit 440.

The wireless receiving unit 430 comprises a low noise amplifier 431, mixers 432A and 432B, low pass filters 433A and 433B, variable gain amplifiers 434A and 434B analog to digital converters 435A and 435B, a local oscillator 436, and a phase shifter 437. The wireless receiving unit 430 comprises two receive paths. The first receive path comprises the mixer 432A, the low pass filter 433A, the variable gain amplifier 434A, and the analog to digital converter 435A. The second receive path comprises the mixer 432B, the low pass filter 433B, the variable gain amplifier 434B and the analog to digital converter 435B.

When a signal is input to the wireless receiving unit 430, the low noise amplifier 431 amplifies the signal, the mixer 432A multiplies it with the local signal from the local oscillator to change to an intermediate frequency. The phase shifter 437 changes the phase of the local signal to a phase different from π/2, and supplies it to the first receive path and the second receive path.

The low pass filter 433A signal then extracts a specified frequency signal from this signal that was changed to an intermediate frequency, and then amplified up to a desired level by the variable gain amplifier 434A. The amplified intermediate signal is then converted to a digital signal by the analog to digital converter 435A, and input to the signal processing unit 450.

The wireless transmitting unit 440 comprises a power amplifier 441 and a pulse generator 442. The signal processing unit 450 generates a signal that is input to the pulse generator 442 that converts it into a specified pulse signal. This pulse signal is then amplified up to a desired level, and sent by way of the switch 411 from the antenna 410.

The switch 411 is interposed between the antenna 410, the wireless receiving unit 430 and the wireless transmitting unit 440. The switch 411 switches the antenna between transmission and reception based on a control signal from the control unit (omitted from drawing).

The configuration of the switch 411 and the wireless transmitting unit 440 is merely one example for achieving wireless communication, and the configuration is not limited to the configuration shown in the drawing. A circulator may be used instead of the switch 411. The variable gain amplifier 434 may be installed in a state prior to the low pass filter 433. Also, a template pulse generator may be used instead of the local oscillator 436 and the phase shifter 437.

The signal processing unit 450 comprises a counter 451 and a memory 452. The counter 451 makes a count for measuring the distance between the reader 400 and the tag 600. The memory 452 stores information acquired from the base station 300 and the tag 600. The memory 452 also stores unique identifiers capable of identifying the reader 400 to the other devices.

The signal processing unit 450 reads the information 453 stored in the memory 452 when necessary and transfers it to the base station 300 and the tag 600, etc.

FIG. 4 shows the configuration of the packet used in wireless transmission between the tag 600 and the base station 400.

A packet 500 includes a preamble, an SFD, a header and data.

The preamble is a specified bit string signal, and is used for bit synchronization on the receiving side. The SFD (Start Frame Delimiter) is a unique bit string signal present between the preamble and the header, or the preamble and the data, and is positioned directly behind the preamble to indicate the starting frame. The header includes the destination address, source address and the data length, etc. The data here is the data to be sent in this packet 500.

The SFD within the packet 500 may be used to apply the timing for starting and stopping the count made by the counter 451. A unique code string may be added to the header or the data to provide the timing for starting and stopping the count.

The reader 400 may comprise a base station 300 function. The reader 400 in that case can connect with the server 100 by way of the network 200 without utilizing the base station 300. The base station 300 and the reader 400 may also be connected by way of a relay station (such as another reader). The relay station comprises a wireless transceiver unit and a signal processing unit for relaying communications between the base station and the reader.

The tag 600 comprises an antenna 610, wireless communication unit 620 and a signal processing unit 630. The signal processing unit 630 comprises a memory 631 for storing information acquired from the reader 400. The memory 631 stores unique identifiers for identifying the tag 600 to the other devices.

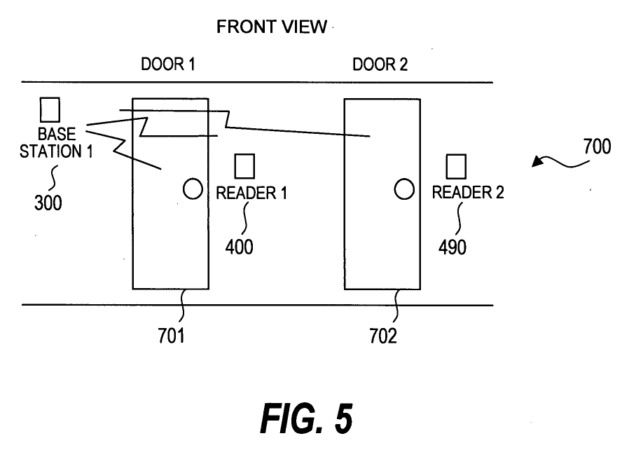

FIG. 5 shows an example applying the authentication system of the first embodiment of this invention to an entry/exit control system.

In the application example 700, two doors 701 and 702 are installed adjacent to each other. The readers 400 and 490 are installed in proximity to each of the doors 701 and 702. The reader 400 is bound with the door 701, and the reader 490 is bound with the door 702.

Each of the doors 701 and 702 comprises a lock, a control unit and a communication unit. When the door open/close instruction signal S506 is received, the doors 701 and 702 are locked or unlocked according to the content of the received door open/close instruction signal S506.

Each of the readers 400 and 490 is connected by wireless (radio) to the base station 300 and send the tag information received by the reader.

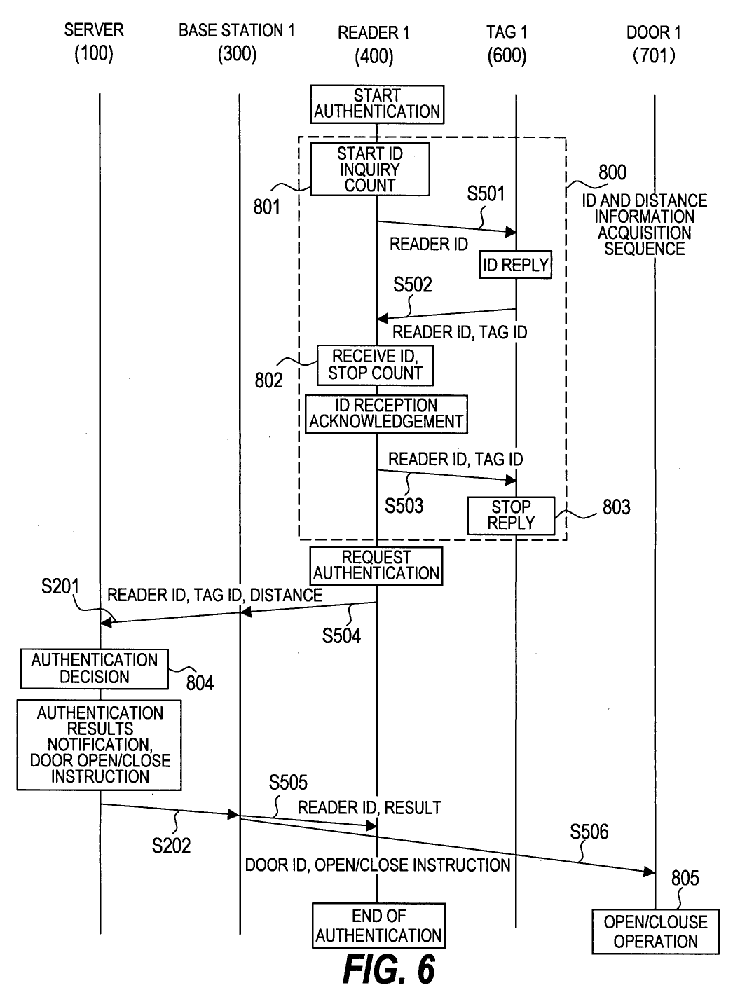

FIG. 6 is a sequence chart for describing an example of the authentication sequence of the first embodiment of this invention. Hereafter, an example of the reader 400 acquiring and authenticating distance information acquired between the reader 400 and the tag 600 and the tag 600 identifier is described while referring to FIG. 6.

First of all, the reader 400 sends an ID query signal S501. The ID query signal S501 includes an identifier for the reader 400. The counter 451 starts counting at a timing sent by the SFD in the ID query signal S501 (801).

The tag 600 next sends an ID reply signal S502 when it receives the ID query signal S501 sent from the reader 400. This ID reply signal S502 includes an identifier for tag 600 sent in the ID reply signal S502, and an identifier for the reader 400 included in the ID query signal S501. The reader 400 identifier and the tag 600 identifier included in ID reply signal S502 may be encrypted by an encrypting means (unique encrypting key in the reader 400) capable of being decoded only the reader 400.

Next, the reader 400 receives the ID reply signal S502. The counter 451 stops counting at the timing received from the SFD within the ID reply signal S502 (802). The reader 400 sends the ID reception acknowledge signal S503 after the counter 451 stops the count. This ID reception acknowledge signal S503 includes a tag 600 ID and a reader 400 ID.

Next, when the ID reception acknowledge signal S503 is received, the tag 600 does not send the ID reply signal S502 for a specified time, even if a ID query signal S501 was sent from the reader 400 (803). The tag 600 may be set so as not to receive the ID query signal S501.

When multiple tags send an ID reply signal S502 in response to one ID query signal S501, then the reader cannot simultaneously reply to the multiple ID reply signals S502. However, the distance information and the multiple tag identifiers present around the reader 400 can be acquired by performing the ID and distance information acquisition sequence 800 multiple times. Acquiring them is possible because the tags already acquired by the reader 400 in the ID and distance information are in a reply stop state (803).

In other words, only tags with un-acquired ID and distance information are sent in the ID reply signal S502 in response, whenever an ID query signal S501 was sent so that repeatedly executing the ID and distance information acquisition sequence 800 serves to decrease the number of tags whose ID and distance information are not yet acquired.

The distance between the reader 400 and the tag 600 is calculated based on the number counted by the counter 451. First of all, a count number equivalent to the time required for signal processing in the tag 600 and the reader 400 is subtracted from the count number in the counter 451. This time required for signal processing may be stored beforehand in the reader 400. Also, information on the time required for internal processing including information on the time required for internal processing in the tag 600 included in the ID reply signal S502 may be sent from the tag 600 to the reader 400 in the ID reply signal S502.

The tag 600 may also resend the ID reply signal S502 when multiple tags have sent the ID reply signal S502 but the reader 400 did not receive the ID reply signals S502 sent from the tag 600. If the tag 600 resends the ID reply signal S502 and it was received by the reader 400, then the elapsed time up to the tag 600 resending the ID reply signal S502 is subtracted from the count by the counter 451.

The counter value calculated by subtracting a figure equivalent to the time required for processing the signal in each device from the count made by counter 451, is equivalent to the propagation time of the ID reply signals S502 and the ID query signal S501. Radio waves propagate at the speed of light in a free space so that the distance between the reader 400 and the tag 600 can be calculated by multiplying the speed of light times the one-way propagation time.

In an entry/exit control system such as in the application example 700 of the first embodiment, the person carrying the tag must be identified so that the distance accuracy must be about 30 centimeters. If the accuracy is approximately 30 centimeters then the first embodiment can be applied even to typical lock/unlock systems. Moreover, the first embodiment may also be applied to the control of air conditioners, lighting, office automation equipment, and household electrical appliances.

Ultra wide band (UWB) wireless communication and in particular UWB impulse radio (UWB-IR) wireless communication are preferable for achieving a measurement accuracy of 30 centimeters. UWB wireless communication is wireless communication that utilizes an extremely wide frequency range above 500 MHz and a center frequency of 20 percent or higher. UWB-IR wireless communication is one type of UWB wireless communications that intermittently sends pulses with a short time width.

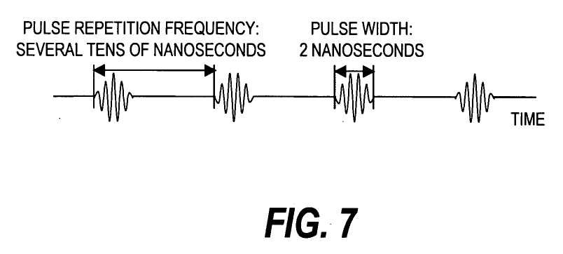

FIG. 7 shows the signal waveform used in UWB-IR wireless communication.

A time resolution of 1 nanosecond is required in order to achieve a distance measurement accuracy of 30 centimeters since the speed of light is 300,000 kilometers per second. In other words, an accuracy of one nanosecond is required in order to detect the peak position of the pulse signal that is used. The pulse width may be shortened to two nanoseconds to achieve this detection. Shortening the pulse width improves the distance accuracy, and lengthening the pulse width degrades the distance accuracy. The pulse width may therefore be adjusted to achieve the required distance accuracy.

The reader 400 also acquires information from other tags in the vicinity by performing the ID and distance information acquisition sequence 800. The reader 400 then attaches a reader identifier to the acquired identifier and distance information to generate the authentication request signal S504. The reader 400 sends the generated authentication request signal S504 to the base station 300. The reader 400 may repeatedly return the ID and distance information acquisition sequence 800 a preset number of times, or may repeatedly send it until tags with non-acquired ID and distance information are no longer detected. Moreover both of these methods may be used. The authentication request signal S504 includes the reader 400 identifier, the tag 600 identifier and information on the distance between the reader 400 and the tag 600.

In the ID and distance information acquisition sequence 800 shown in FIG. 6, the reader 400 sends a signal before the tag 600, and the reader 400 acquires the tag 600 identifier and the distance information. In this case the tag 600 must be set to the reception standby state so that the ID query signal S501 may be sent at any time from the reader 400. The wireless communication unit 620 of tag 600 may have the same configuration as the wireless communication unit 420 of the reader 400. However the tag 600 may separately comprises a simple RF detector for detecting the intensity of the reception signal, and may use this simple RF detector in the reception standby state, and stop the operation of the wireless communication unit 620. When the reader 400 sends the ID query signal S501, the simple RF detector detects the intensity of the received ID query signal S501, and starts the wireless communication unit 620 operation. The tag 600 is in this way set to a state where the ID and distance information acquisition sequence 800 can be executed. The power consumption in the tag 600 reception standby state can be reduced in this way using a simple RF detector.

When the authentication request signal S504 is received, the base station 300 forwards the received authentication request signal S504 to the server 100.

When the authentication request signal S201 is received from the base station 300, the server 100 checks the authentication data 111 and make the authentication decision (804). More specifically, the server 100 compares the contents of the received authentication request signal S201 with the authentication data 111 stored in the authentication database 110, and decides whether or not the authentication conditions are satisfied. This authentication data 111 includes the reader identifier, the tag identifier, and the distance information between the reader and the tag. When the reader 1 (400) for example has requested authenticating of the tag 1 (600), then authentication is a pass if the distance between the reader 400 and the tag 600 is less than 30 centimeters per the authentication data 111. If the reader 3 (491) has requested authentication of the tag 2 (690) then authentication fails regardless of the distance between the reader 491 and the tag 690.

When the authentication decision ends, the server 100 sends the authentication result notification signal S202 to the base station 300. The base station 300 forwards the contents of authentication result notification signal S202 to the reader 400 and the door 701 when needed.

When the authentication result notification signal S505 is received, the reader 400 performs the specified operation based on the authentication results. The reader 400 for example, may inform a person carrying the tag 600 of the received authentication results by some means (for example, display or sound). The reader 400 may repeat the return of the ID and distance information acquisition sequence 800.

The door 701 may perform the specified operation based on the authentication results, when the door open/close instruction signal S506 is received (805). If the authentication results for example are a success then the door 701 is unlocked, and if the authentication results are failures then the door 701 is locked. The door 701 may comprises a speaker or a display to issue a warning if the authentication results are failures.

If the door 701 is connected with the network 200 and not by way of the base station 300, then the server 100 may send the door open/close instruction signal S506 without using the base station 300. Also if the door 701 is connected to another base station or reader, then the door open/close instruction signal S506 may be relayed via those devices.

A variation of the above described authentication sequence is described next. In the authentication sequence shown in FIG. 6, the reader 400 sent the signal before the tag 600. However, in another method the tag 600 may send the signal prior to the reader 400, and the reader 400 then acquires the tag 600 identifier and the distance information.

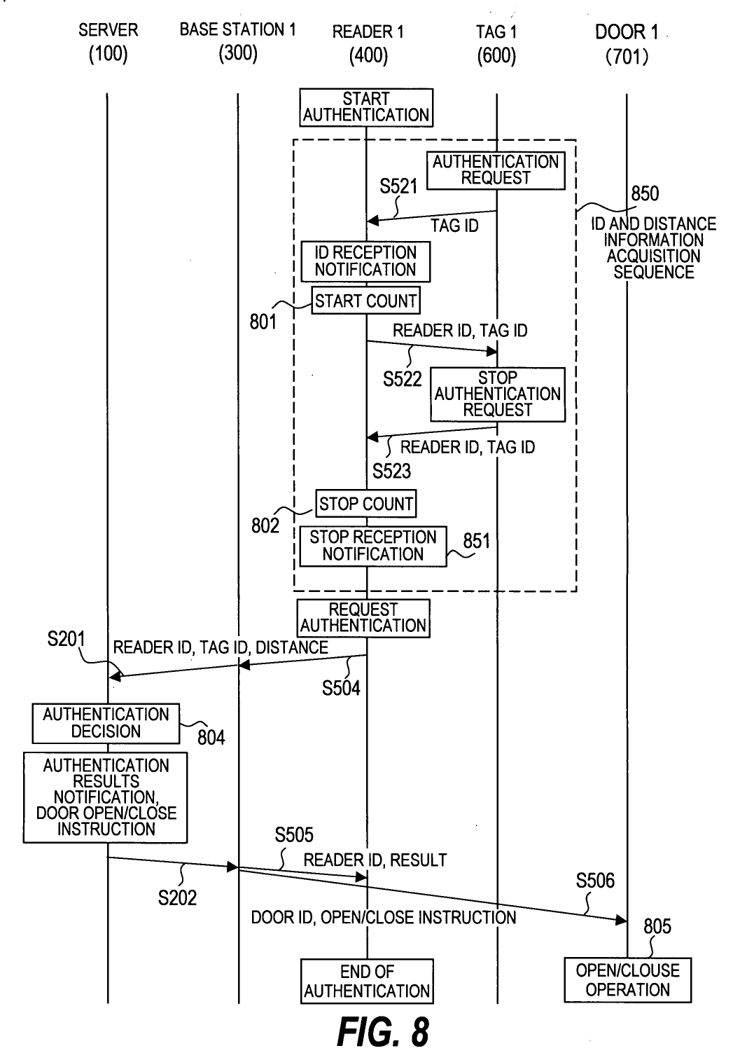

FIG. 8 is a sequence chart for describing an example of the authentication sequence when the tag 600 is requesting authentication of the reader 400.

The tag 600 first of all sends an authentication request signal S521 to the reader 400.

The tag 600 comprises an operating unit, and for example the tag 600 may send the authentication request signal S521 by operating this operating unit. The tag 600 may also send the authentication request signal S521 periodically. The authentication request signal S521 includes an identifier for the tag 600.

When it receives the authentication request signal S521, the reader 400 sends the ID reception acknowledge signal S522. The ID reception acknowledge signal S522 includes the identifier for the reader 400 sending the ID reception acknowledge signal S522, and the identifier for tag 600 includes in the authentication request signal S521. The counter 451 starts the count, at the timing sent per the SFD in the ID reception acknowledge signal S522 (801).

Next, the tag 600 sends the authentication request stop signal S523 after receiving the ID reception acknowledge signal S522. This authentication request stop signal S523 includes a reader 400 identifier and a tag 600 identifier.

Next, the reader 400 receives the authentication request stop signal S523. The counter 451 stops counting at the timing received in the SFD in the authentication request stop signal S523 (802). The reader 400 is set so as not to send the ID reception acknowledge signal S522 when the authentication request stop signal S523 is received, even if the authentication request signal S521 is received from the tag 600 in the specified time (851). The reader 400 may also be set so as not to receive the authentication request signal S521.

The tag 600 may utilize the authentication request signal S521 and the ID reception acknowledge signal S522 for the distance between the reader 400 and the tag 600. To find the distance, the tag 600 must possess the same counter as the counter 451 in the reader 400. Moreover, the authentication request stop signal S523 must also include distance result information as well as the reader 400 identifier and the tag 600 identifier.

The method where the tag 600 utilizes the authentication request signal S521 and the ID reception acknowledge signal S522 for the distance, may be used along with the method where the reader 400 finds the distance using the ID reception acknowledge signal S522 and the authentication request stop signal S523.

The ID and distance information acquisition sequence 850 is complete in the process up to this point.

The reader 400 then sends the authentication request signal S504. The remainder of the processing is the same as the authentication sequence shown in FIG. 6.

In the first embodiment as described above, the reader 400 can acquire both the tag 600 identifier and the distance information just by wireless communication for authentication between the reader 400 and the tag 600. There is therefore no need to install new equipment for measuring the distance between the reader 400 and the tag 600 or communication just for the distance. The equipment can therefore be made smaller. Moreover, the power consumption of the equipment can be reduced. Also, the time required for authentication can be shortened.

Namely, a number of the signal transmission/reception between the authenticating device and the authentication target device is reduced by half compared to the above described virtual technology of the related art, so that the power consumption can be reduced.

Moreover, if the reader 400 measures the distance, then it does not need to include distance information in the data so that making the packet longer can be prevented and therefore increased packet traffic can be prevented.

Moreover, the distance can be obtained with high accuracy compared to the method of the related art using GPS. Though the accuracy of GPS is within several meters, in the first embodiment of this invention, accuracy with a few dozens centimeters can be achieved. Moreover, in GPS receiving radio waves from the satellite while indoors is difficult, however in the first embodiment of this invention can easily be used indoors.

Unlike the related art utilizing an acceleration sensor, the first embodiment requires no initial settings.

The method of the related art where the tag finds the distance, requires a minimum of two communications between the tag and the reader. In the first embodiment on the other hand, a minimum of one communication between the tag and the reader is sufficient The unlocking of the adjacent door 702 was avoided when attempting to unlock the door 701 via the tag 600 after making appropriate authenticating data 111 settings so that the security and convenience are improved.

The reader device cost can also be lowered since the reader and the tag can be made smaller and with less power consumption. Moreover the tag is easily carried by people and the tag is easily attached to objects. Making the tag easy to carry and attach to objects raises restrictions on the location and environment so that this invention can be used not only for entry/exit control but also in authentication systems for diverse applications such as control of general-purpose electronic devices and lock/unlock systems. This invention for example can be applied to electronic devices where the power turns on when people carrying tags approach or to lock and unlock pharmaceutical storages vaults, etc.

Moreover, the authentication system of this invention can be applied to a variety of applications just by changing the settings on the authentication database 110, and can flexibly respond to changes and additions to systems and applications.

### Second Embodiment

The second embodiment of this invention is described next. In the first embodiment, the distance between the tag and the reader was an authentication condition. In the second embodiment, the authentication conditions further include the tag direction.

The authentication system of the second embodiment comprises a server 100, a network 200, a base station 300, an authenticating device (reader) 400, an authentication target device (tag) 600 and a control object (door) 701. The configuration of the server 100, a base station 300, a reader 400 in this second embodiment are different from the first embodiment. Components with the same configuration as the first embodiment are given the same reference numerals and their description is omitted.

The server 100 connects to the base station 300 by way of the network 200. The base station 300 is connected by wireless communication with the reader 400 and the door 701. The reader 400 is connected by wireless communication with the tag 600.

The base station 300 and the door 701 may be connected by cable communication. The door 701 may connect to the reader 400. The door 701 may connect by way of the network 20 with the server 100.

The reader 400 and/or the door 701 may include a base station function. A relay station may also be installed between the reader 400 and the base station 300. Multiple base stations, readers, tags and doors may be installed.

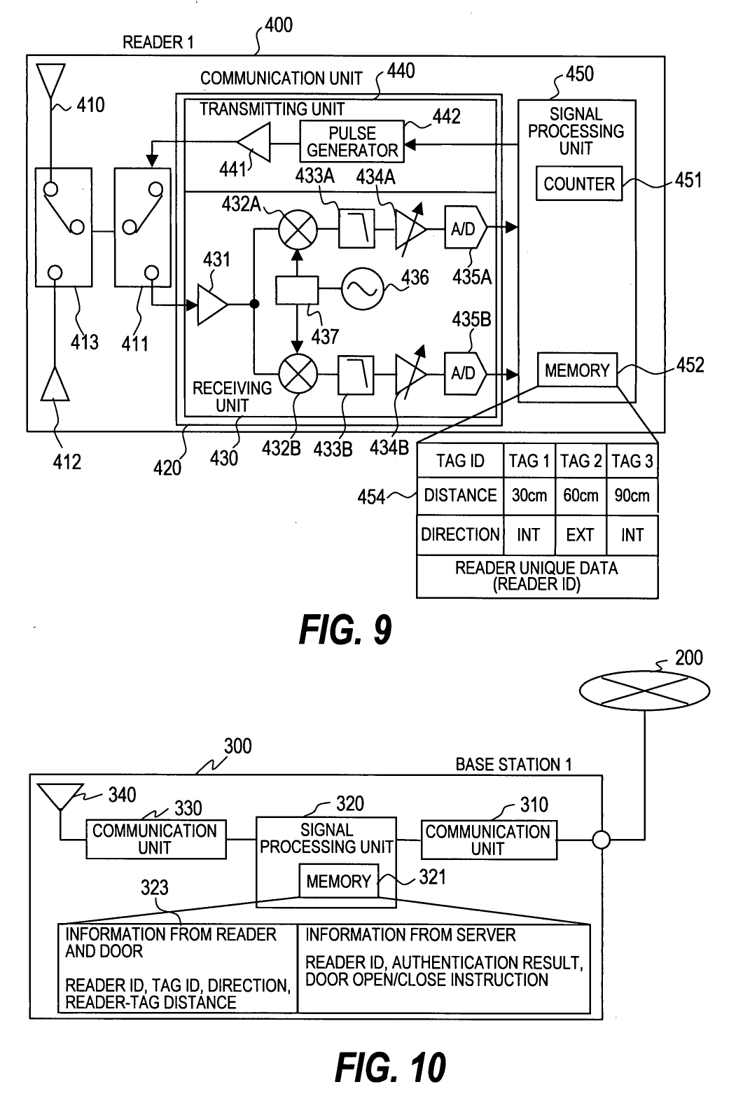

FIG. 9 is a block diagram showing a typical configuration of the reader 400 in the second embodiment of this invention.

The reader 400 comprises an antenna 410 and an antenna 412. The reader 400 further comprises a selector switch 413 for switching between the antenna 410 and the antenna 412. The antenna 410 is used only for communication inside a room, and the antenna 412 is used only for communication outside the room.

The memory 452 stores the acquired tag identifier, the distance information between the reader and the tag, and the reader identifier and the direction information indicating inside/outside the room. A signal processing unit 450 reads the information 454 stored in the memory 452 as needed, and sends it to the base station 300 and the tag 600.

FIG. 10 is a block diagram showing a typical configuration of the base station 300 of the second embodiment of this invention. The base station 300 stores the information 323 including the direction information acquired from the reader 400, in the memory 321.

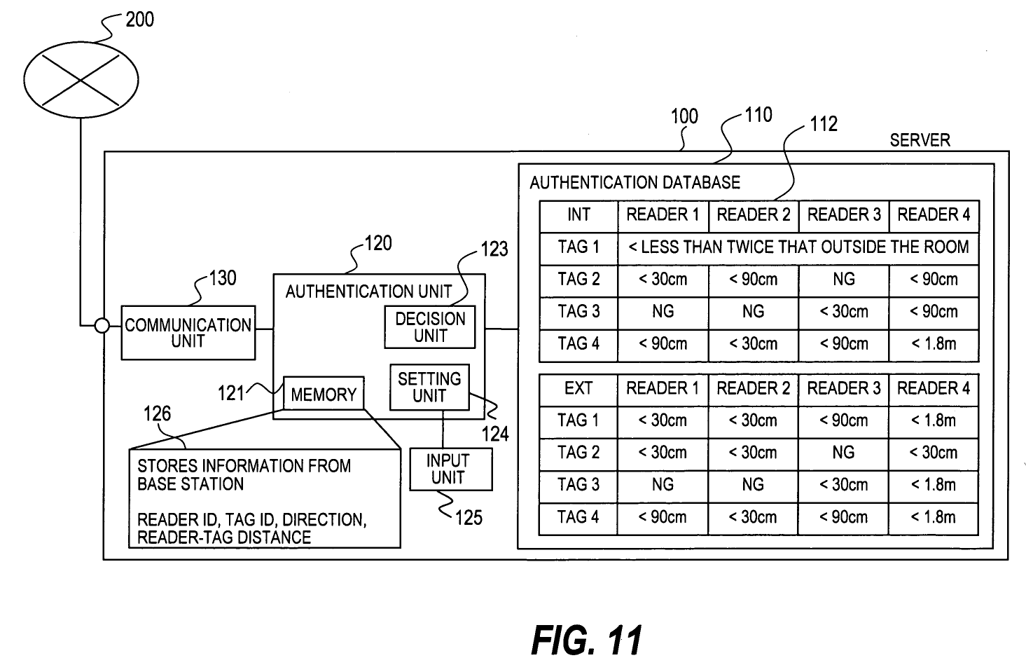

FIG. 11 is a block diagram showing a typical configuration of the server 100 of the second embodiment of this invention. The server 100 stores authentication data 112 including direction information and distance information between the tag and reader, a reader identifier, and a tag identifier, in the authentication database 110. The server 100 stores the information 126 including direction information acquired from the base station 300, in the memory 121.

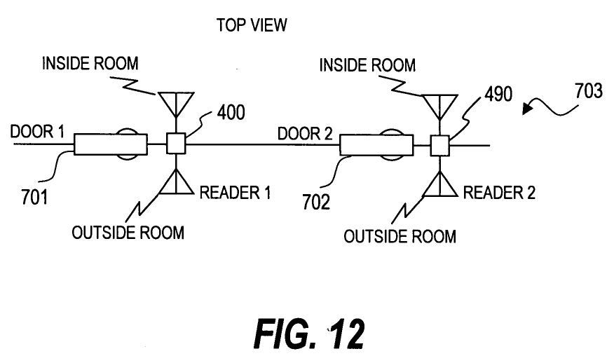

FIG. 12 shows an example applying the authentication system of the second embodiment of this invention to an entry/exit control system. FIG. 12 shows the state as viewed from above the authentication system of the second embodiment.

Two doors 701 and 702 are installed adjacently in the application example 703. Two readers 400 and 490 are installed in the vicinity of the each door 701 and 702. The reader 400 is bound with to the door 701, and the reader 490 is bound with the door 702.

Each of the readers 400 and 490 comprises two antennas inside and outside the room, and communicate inside/outside the room via each antenna. The readers 400 and 490 can, in this way, be classified into inside/outside room.

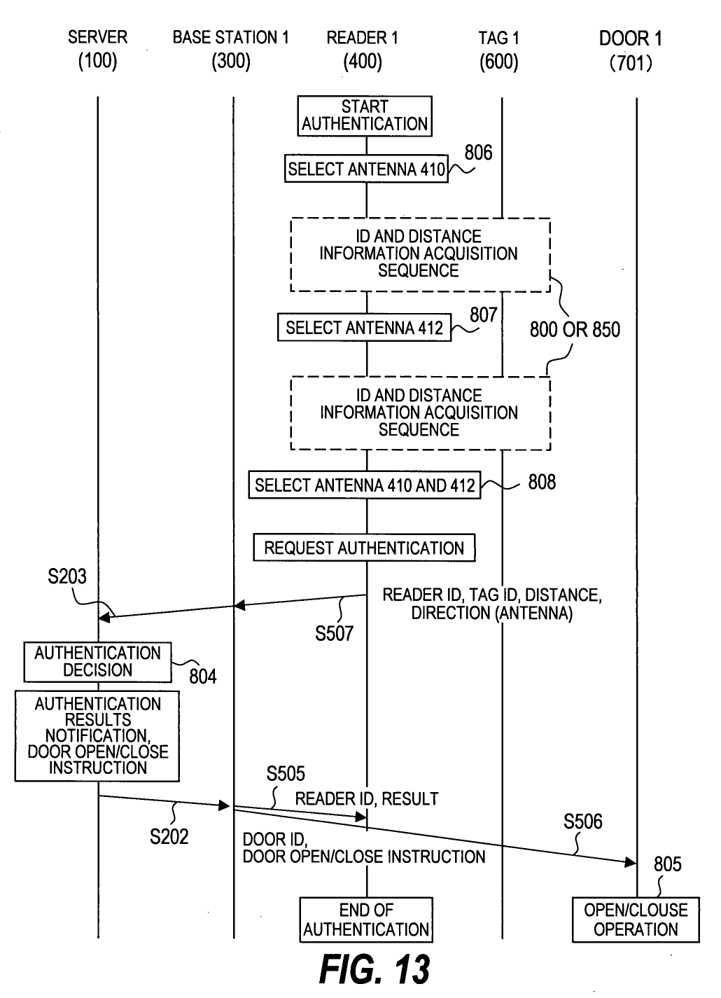

FIG. 13 is a sequence chart for describing a typical authentication sequence of the second embodiment of this invention. The acquisition of distance information between the tag 600 and the reader 400 and the tag 600 identifier by the reader 400 is described while referring to FIG. 13. An example of acquiring direction information by switching between the antenna 410 and the antenna 412, and authentication is also described.

First of all, the reader 400 selects the first antenna 410 (806), and executes the ID and distance information acquisition sequence 800 for inside the room. The reader 400 next selects the second antenna 412 (807) and executes the ID and distance information acquisition sequence 800 for outside the room in the same way. The direction information is information showing whether the tag 600 identifier and the distance information for either antenna selection 806 and 807, and specifies whether the tag 600 is inside or outside the room.

If known beforehand at this time that there is no tag inside the room for authentication, then the selection 806 of antenna 410 may be omitted, and the authentication process started from the selection 807 of antenna 412. On the other hand if known beforehand that there is no tag outside the room for authentication, then the selection 807 of antenna 412 may be omitted. Omitting these steps will serve to shorten the authentication time, and reduce the power consumption.

When the distance information and the tag 600 identifier has been acquired by either antenna selection 806 or 807, then the tag 600 can be identified as being inside or outside the room by way of the antenna that acquired information at a strong signal intensity.

The ID and distance information acquisition sequence 850 (refer to FIG. 8.) may be executed instead of the ID and distance information acquisition sequence 800.

The reader 400 repeatedly executes the ID and distance information acquisition sequence multiple times utilizing each antenna, and acquires the distance information and the identifiers for tags in the surrounding area. The reader 400 then selects both the antenna 410 and the antenna 412 (808), and sends an authentication request signal S507 to the base station 300. The authentication request signal S507 and S203 include a reader 400 identifier, a tag 600 identifier, and the distance information between the tag 600 and the reader 400 as well as tag 600 direction information.

If already known at this time that the base station 300 is inside the room, then the reader 400 does not need to select both the antenna 410 and the antenna 412 by the antenna selection 808. In other words, the reader 400 may select just the antenna 410, and send the authentication request signal S507 only to inside the room. If the base station 300 on the other hand is already known to be outside the room, then the reader 400 selects only the antenna 412, and may send the authentication request signal S507 just outside the room. Transmission of unnecessary radio waves can in this way be limited, and the power consumed by the power amplifier 441 of wireless transmitting unit 440 can be reduced.

When the authentication request signal S203 is received, the server 100 collates the authentication request signal S203 information with the authentication data 112 and makes an authentication decision (804). The server 100 subsequently notifies the reader 400 of the authentication results and instructions the door 701 to open or close (S506 and 805).

The authentication data 112 includes a reader identifier, a tag identifier, as well as direction information and distance information between the reader and the tag. When the reader 1 (400) for example requests authentication of the tag 1 (600), if the tag 600 is outside the room then the distance between the reader 400 and the tag 600 is less than 30 centimeters so authentication succeeds. On the other hand if the tag 600 is inside the room, then the distance between the reader 400 and the tag 600 is less than twice that when outside the room (60 centimeters) and the authentication succeeds.

The examples in FIG. 9 and FIG. 13 showed examples utilizing two antennas however three or more antennas may be used according to the application. Utilizing three or more antenna allows obtaining more accurate direction information. Three or more antennas may also be used for the antennas for communicating with the base station, and the antennas for communicating with the tags.

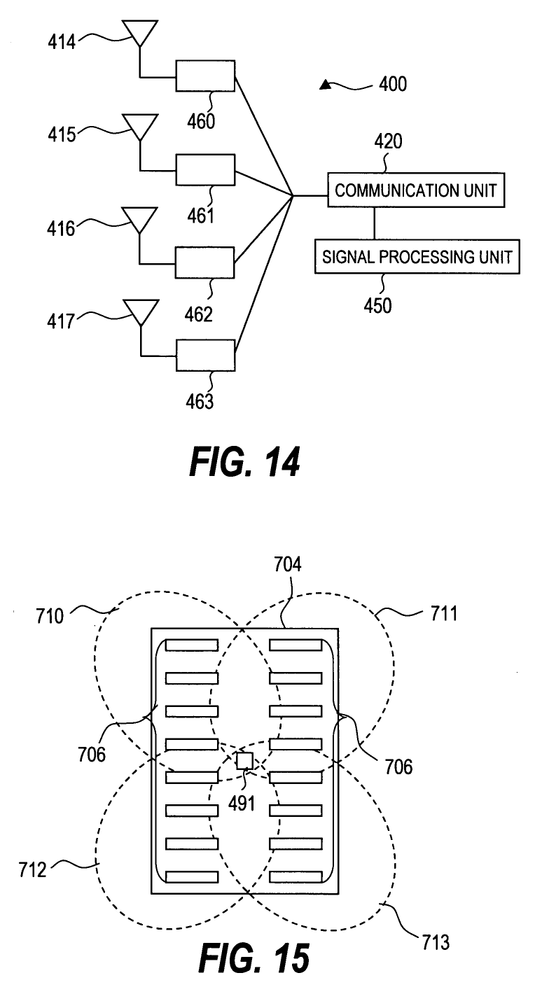

Moreover, antennas may be used for obtaining detailed direction information. FIG. 14 is a block diagram showing a typical configuration for the reader 400 comprising an antenna array.

The reader 400 shown in FIG. 14 comprises antenna elements 414, 415, 416 and 417 making up the antenna array, and phase-amplitude adjusters 460, 461, 462 and 463; a wireless communication unit 420, and a signal processing unit 450. The signal received by each of the antenna elements 414 through 417 is input to the phase-amplitude adjusters 460 through 463, and adjusted to the desired amplitude and phase. Then, the signal output from these phase-amplitude adjusters 460 through 463 is mixed and input to the wireless communication unit 420.

The reader 400 configured in this way, can estimate the direction that the signal sent from the tag will arrive, based on the power and phase received at each antenna making up the antenna array. Besides estimating the arrival direction, the reader 400 can also send the signal aimed at a specified direction by adjusting the phase and power sent from each antenna.

FIG. 15 through FIG. 17 are drawings for describing other examples applying the authentication system of the second embodiment of this invention.

FIG. 15 shows an example of the second embodiment of this invention applied to control of room lighting.

The reader 491 comprises four directive antennas and is installed in the center of a room 704 where the lighting jig 706 is mounted. Each of the antennas is capable of wireless communication with a communication area 710, 711, 712 and 713. The reader 491 identifies which of the communication areas 710, 711, 712 and 713 that the tag is in. If a tag is present (if there is a person carrying the tag) then the lighting jig 706 is turned on, and if there is no tag (if there is no person carrying the tag) then the lighting is turned off. The lights can in this way automatically be turned off when not needed and costs can be lowered.

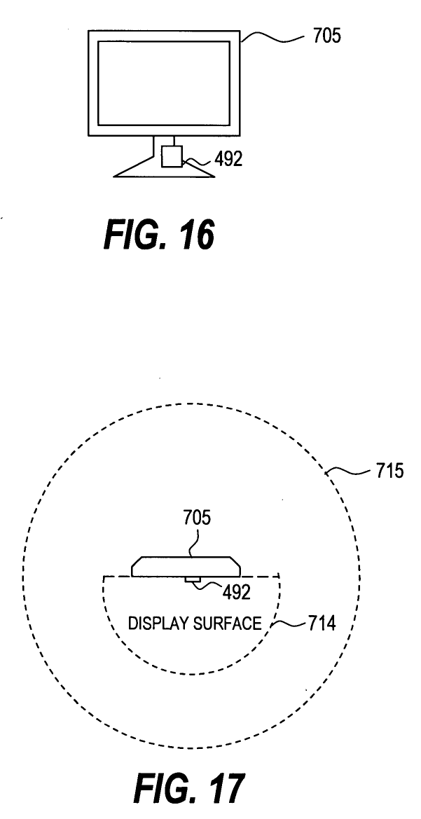

FIG. 16 and FIG. 17 show examples applying the second embodiment of this invention to a display device. FIG. 16 is a frontal view of the display device. FIG. 17 is an upper view of the display device.

The reader 492 comprises a directive antenna and a non-directive antenna installed in the display device 705. The directive antenna can communicated in the communication range 714. The non-directive antenna can communicate in the communication range 715. The communication range 714 of the directive antenna is adjusted to a range where the information displayed on the display device can be recognized visually.

The reader 492 authenticates the tag utilizing a directive antenna, and communicates with the base station using the non-directive antenna. The reader 492 can therefore authenticate tags present in the communication range 714.

For example, when a tag possessing rights is present within the communication range 714, then a decision is made that a person with rights to view that information is facing the display device, and confidential information is displayed on that display device. However when the person with rights moves away from the front of the display device, then the tag possessing rights can no longer be authenticated so the contents shown on the display device are changed, and leakage of information is prevented. The contents shown on the display device can be changed to prevent leakage of information for just the case where a person with no rights to view the information enters within visual recognition range of the display device. The security of information shown on the display device can in this way be enhanced.

The second embodiment can therefore utilize a device including multiple antennas to identify the direction where a tag is present. Besides the ID and distance information, the direction information can also be added to the authentication conditions, to allow setting more detailed authentication conditions. The security and convenience can therefore be upgraded to an even higher level.

### Third Embodiment

The third embodiment of this invention is described next. The authentication condition of the first embodiment was the distance between the tag and the reader. However, authentication conditions for the third embodiment include information on the distance between the tag and the multiple readers.

The authentication system of the third embodiment comprises a server 100, a network 200, a base station 300, an authenticating device (reader) 400, a reader 490, an authentication target device (tag) 600 and a control object (door) 708. In the third embodiment, the configuration of the server 100 and the base station 300 are different from those of the first embodiment. Components with the same configuration as the first embodiment are given the same reference numerals and their description is omitted.

The server 100 is connected to the base station 300 by way of the network 200. The base station 300 connects by wireless communication to the reader 400, the reader 490 and the door 708. The readers 400 and 490 connect by wireless communication to the tag 600.

The base station 300 and the door 708 may be connected by wire communication. The door 708 may connect to the readers 400 and 490. The door 708 may connect by way of a network 200 to the server 100.

Any of the reader 400, the reader 490 and the door 708 may include a base station function. A relay station may be installed between the reader 400 and the base station 300 and/or between the reader 490 and the base station 300. The readers 400 and 490 may connect via respectively different base stations to the server 100. Multiple base stations, readers, tags and doors may be installed.

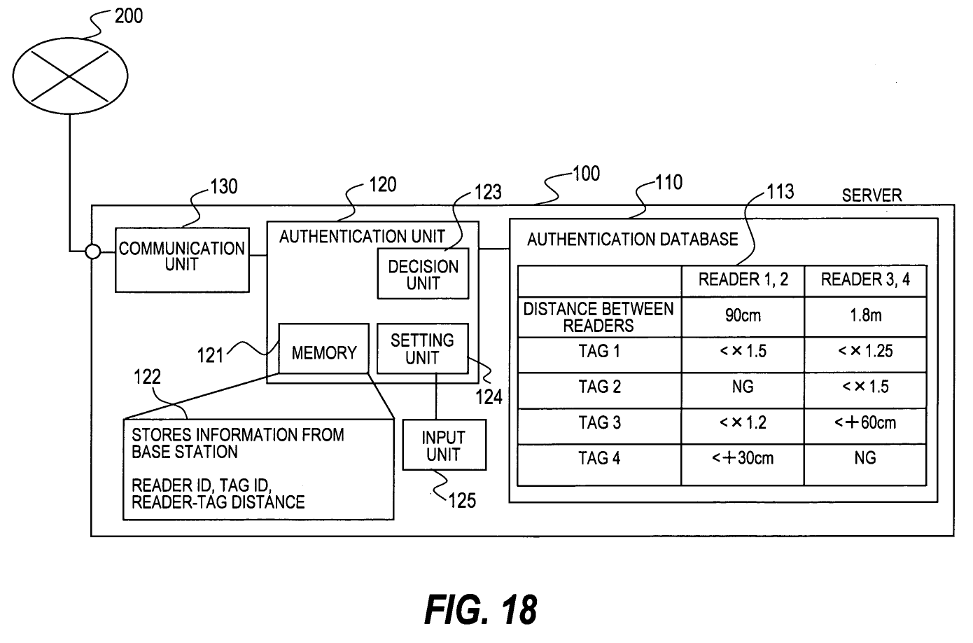

FIG. 18 is a block diagram showing the configuration of the server 100 of the third embodiment of this invention. The server 100 stores authentication data 113 including authentication information between the reader and the tag, as well as distance information between readers, reader identifier, and tag identifier, in the authentication database 110. The distance between readers is measured by sending and receiving the distance measurement start signal S513 and the distance measurement end signal S514 between the applicable readers.

Distance information between the reader and the tag is set beforehand based on the distance between readers. Authentication conditions are defined for example by relation of the sum of the distance between the tag and two of the readers, and the distance between the readers. More specifically, authentication is a success if the sum of the distance between the tag 600 and the reader 400, and the distance between the tag 600 and the reader 490 is less than 1.5 times the 90 centimeter distance between the readers 400 and 490. Authentication may also be a success if the sum of the distance between the tag 600 and the reader 400, and the distance between the tag 600 and the reader 490 is within 30 centimeters (in other words, within 120 centimeters) of the 90 centimeter distance between the reader 490 and the reader 400.

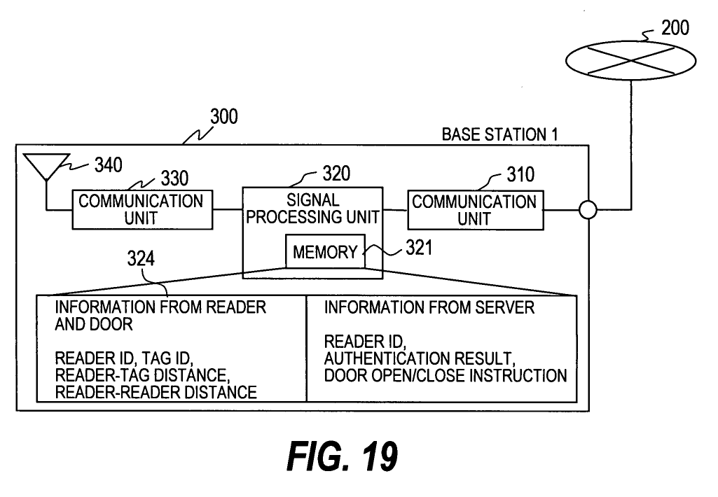

In other words, in the third embodiment, the authentication conditions are defined as the sum of the distance between the tag and two of the readers, compared with a specified value added to the distance between readers or a value multiplied by a specified value FIG. 19 is a block diagram showing the configuration of the base station 300 of the third embodiment of this invention.

The base station 300 stores in a memory 321, information 324 included in an inter-reader distance measuring instruction signal S204 and an inter-reader distance measuring result notification signal S512 received from the server 100. The base station 300 sends the information 324 stored in the memory 321, to the server 100, the readers 400 and 490 when needed.

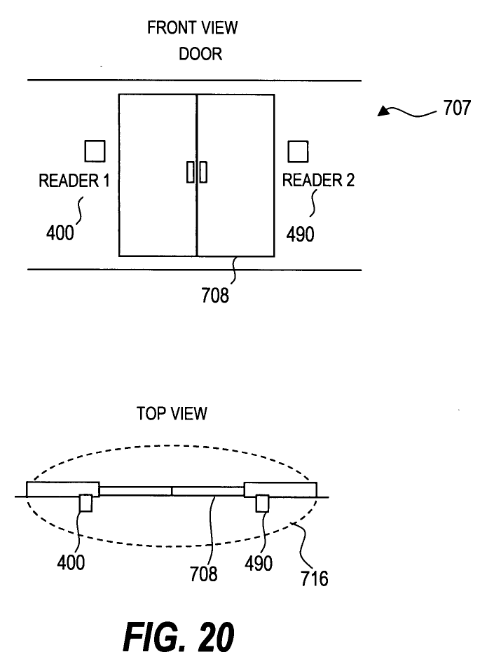

FIG. 20 is drawings showing an example of the authentication system of the third embodiment of this invention applied to an entry/exit control system. FIG. 20 is a view of the authentication system of the third embodiment as seen from the front and from the top.

In the application example 707, the readers 400 and 490 are installed on both sides of a door 708 that opens and closes by sliding to the left and right. The readers 400 and 490 are bound with the door 708.

Authentication conditions in the third embodiment include distance information between the multiple readers and the tag. For example as described previously, if the sum of the distance between the tag 600 and the reader 400, and the distance between the tag 600 and the reader 490 is less than 1.5 times the 90 centimeter distance between the readers 400 490, then the elliptical authentication area 716 is established.

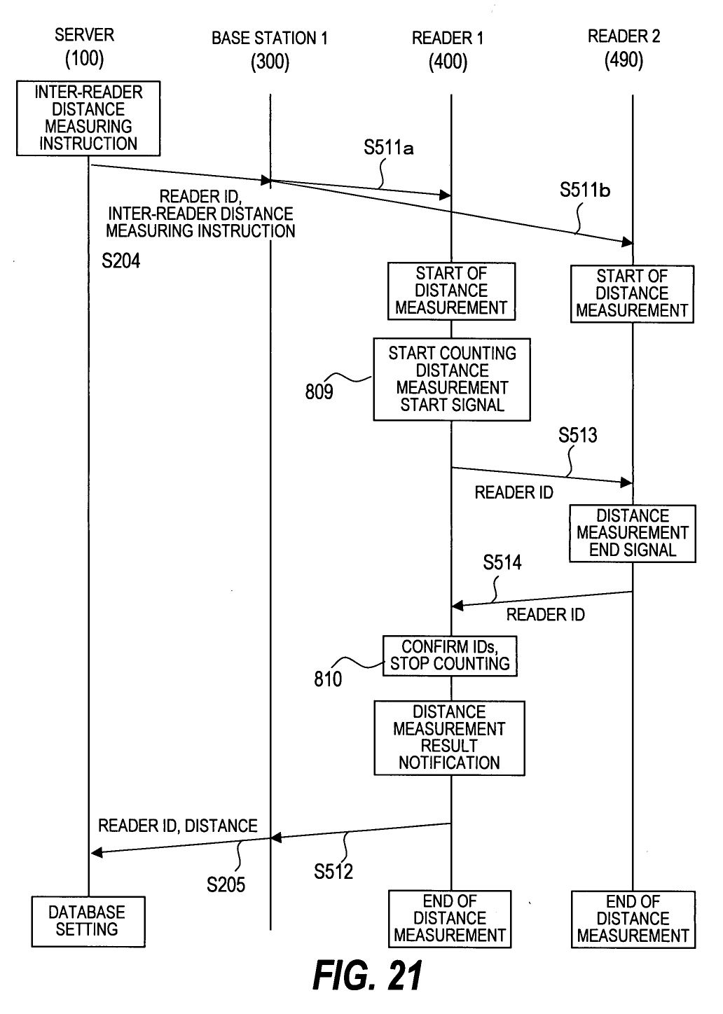

FIG. 21 is a sequence chart for describing an example of the authentication database setting sequence of the third embodiment of this invention. This setting sequence may be executed when the system starts up, or may executed just one time as an initial setting when constructing the system, or may be executed periodically.

The server 100 first sends an instruction signal S204 to the reader s400 and 490 to measure the distance between the readers 400 and 490. This inter-reader distance measuring signal S204 includes information showing a reader identifier (identifier of the reader 400 and 490) for measuring as well as a measuring instruction for the distance. The server 100 sends the inter-reader distance measuring signal S204 to each reader by way of the base station 300.

The readers 400 and 490 start measuring the distance between readers when the inter-reader distance measurement instruction signal S511A and S511B are received. The inter-reader distance measurement instruction signal S511 also includes information for sending the distance measurement start signal S513 from either of the readers. In the case shown in FIG. 21, the reader 400 sends the distance measurement start signal S513 and measures the distance, or the reader 490 may send the distance measurement start signal S513 and measure the distance.

Next, the reader 400 sends the distance measurement start signal S513 for measuring the distance with the reader 490. The distance measurement start signal S513 includes an identifier of reader 400 and 490. The counter 451 starts counting at the timing when the SFD included in the distance measurement start signal S513 is sent (809).

When the distance measurement start signal S513 is received, the reader 490 sends the distance measurement end signal S514. The distance measurement end signal S514 includes the identifier of the reader 400 and 490.

The reader 400 next receives the distance measurement end signal S514. The counter 451 stops the count at the timing received in the SFD within the distance measurement end signal S514 (810). As described in the first embodiment, the propagation time for the signal is found from the counter 451 counter value, and the distance information between the readers is from the propagation time for the signal.

Next the reader 400 attaches the reader 400 identifier and the reader 490 identifier to the acquired distance information and generates a distance measuring result notification signal S512. Then, the reader 400 sends this generated distance measuring result notification signal S512 to the base station 300.

When the distance measuring result notification signal S205 is received, the base station 300 sends the distance measuring result notification signal S205 to the server 100.

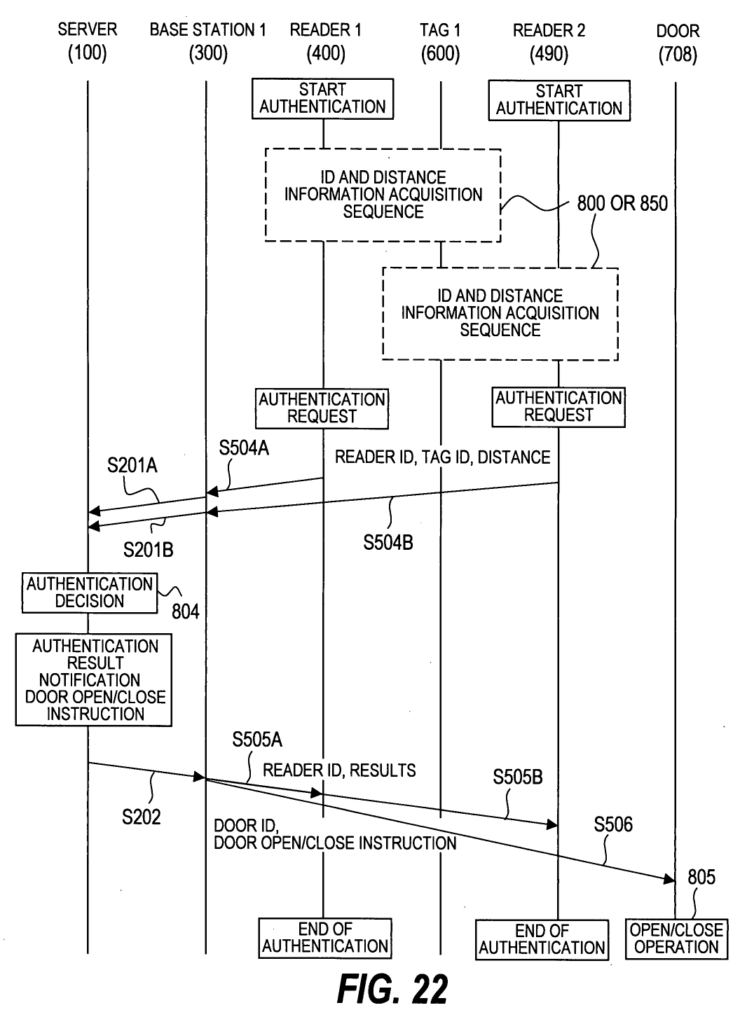

FIG. 22 is a sequence chart for describing an example of the authentication sequence of the third embodiment of this invention. An example of the readers 400 and 490 acquiring distance information between the tag 600 and identifier of tag 600, and then authenticating this information is described while referring to FIG. 22.

First of all, the readers 400 and 490 respectively execute the ID and distance information acquisition sequence 800. The ID and distance information acquisition sequence 800 is executed multiple times to acquire information on tags present around the readers 400 and 490. The ID and distance information acquisition sequence 850 may be executed instead of the ID and distance information acquisition sequence 800 (refer to FIG. 8.)

Next, the readers 400 and 490 attach the respective reader identifiers to the acquired identifier and the distance information, and generate the authentication request signals S504A and S504B. These generated authentication request signals S504A and S504B are sent to the base station 300. The information includes in these received authentication request signals S504A and S504B is sent to the server 100 by way of the authentication request signals S201A and S201B.

The server 100 that received the authentication request signal S201, collates the authentication data 113 stored in the authentication database 110, with the information 122 included in the authentication request signal S201 stored in the memory 121, and makes the authentication decision (804). If an authentication request for example is received from the reader 1 (400) and the reader 2 (490) for the authentication data 113, then the authentication is a success, if the sum of the distance between the tag 1 (600) and the reader 1 (400), and the distance between the tag 1 (600) and the reader 2 (490) is less than 1.5 times the 90 centimeter distance between the readers 400 and 490 measured in the measurement sequence shown in FIG. 21. Also, the authentication is a success if the sum of the distance between the tag 3 (691) and the reader 3 (491), and the distance between the tag 3 (691) and the reader 4 (492) is lower than the distance 1.8 meters added with 60 centimeters between the tag 4 (492) and the reader 3 (491) measured in the setting sequence shown in FIG. 21.

Hereafter, just as described in the first embodiment, the authentication results are notified (S202, S505A and S505B) to the readers 400, 490 via the base station 300, and the door 708 is instructed to open or close the door (S506 and 805).

The examples shown in FIG. 21 and FIG. 22 used two readers but may utilize three or more readers. If three or more already known reader positions are used, then the tag positions can be specified by 3-point measurement (e.g. triangulation). Moreover, the example shown in FIG. 22 used the sum of the distances between the tag and each of the reader to decide if authentication was a success or not. However the authentication may also be decided a success or not using results from calculating the distance between the reader and the tag. More appropriate authentication conditions can be set by means of various calculations not limited to sum.

Moreover, distance information between the tags and the tag identifiers was acquired by all readers, however the distance information between the tags and the tag identifiers may be acquired by just a portion of the readers. In other words, one among the readers may execute the ID and distance information acquisition sequence 800. In this case, a decision on whether authentication was established may be decided using the distance information between the tag and the reader executing the ID and distance information acquisition sequence 800. Other readers not executing the ID and distance information acquisition sequence 800 may substitute for the tags.

The third embodiment as described above, allows setting more detailed authentication conditions by installing multiple compact readers, and security and convenience can be upgraded to an even higher level.

### Fourth Embodiment

The fourth embodiment of this invention is described next. The authentication condition of the first embodiment was the distance between the tag and the reader. However, authentication conditions for the fourth embodiment further include the control status of the control objects. Namely, the distance condition for authentication to succeed is changed in the fourth embodiment to the door status.

The authentication system of the fourth embodiment comprises a server 100, a network 200, a base station 300, an authenticating device (reader) 400, an authentication target device (tag) 600 and a control object (door) 701. In the fourth embodiment, the configuration of the server 100 and the base station 300 are different from those of the first embodiment. Components with the same configuration as the first embodiment are given the same reference numerals and their description is omitted.

The server 100 is connected to the base station 300 by way of the network 200. The base station 300 connects by wireless communication to the reader 400 and the door 701. The reader 400 connects by wireless communication to the tag 600.

The base station 300 and the door 701 may be connected by wire communication.

The door 701 may connect to the reader 400. The door 701 may connect by way of a network 200 to the server 100.

The reader 400 and/or the door 701 may include a base station function. A relay station may be installed between the reader 400 and the base station 300. Multiple base stations, readers, tags and doors may be installed.

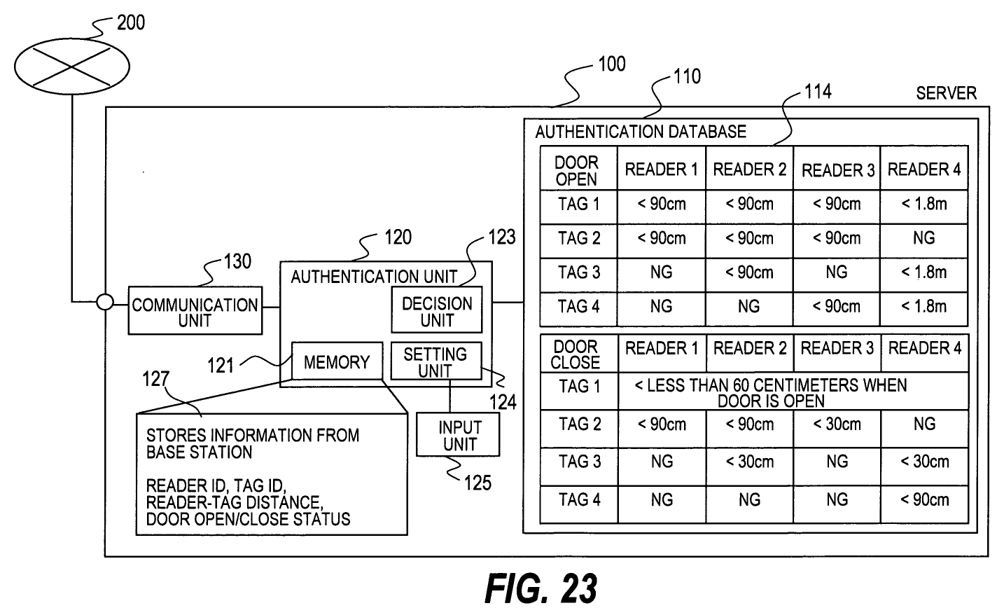

FIG. 23 is a block diagram showing the configuration of the server 100 of the fourth embodiment of this invention. The server 100 stores authentication data 114 including a tag identifier, the reader identifier and distance information between the reader and the tag in the authentication database 110 for both when the door is closed and when open. The server 100 stores information 127 included in the door open/close notification signal S206 and the authentication request signal S201, into the memory 121.

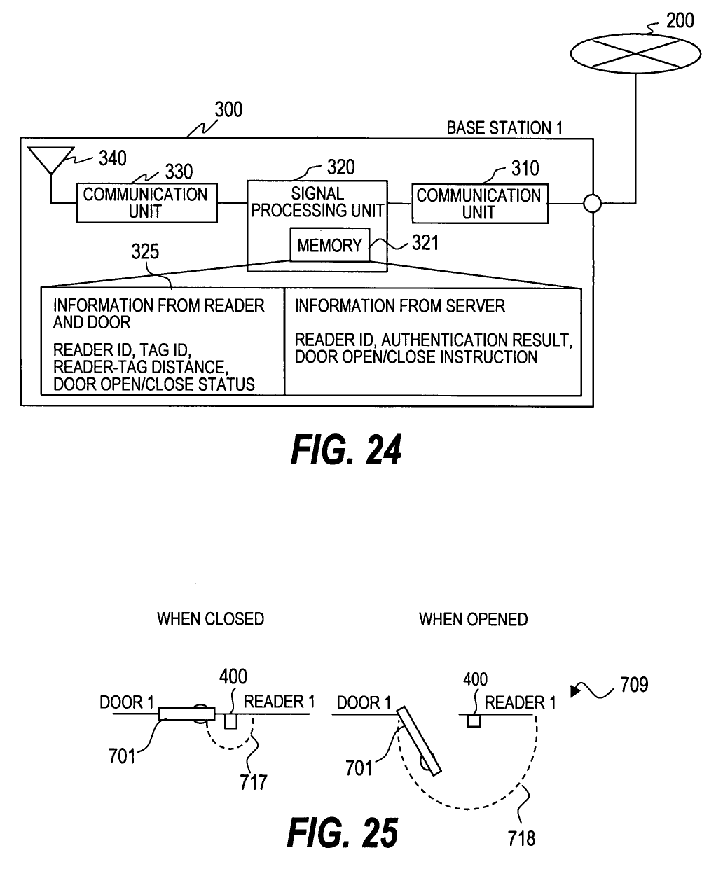

FIG. 24 is a block diagram showing the configuration of the base station 300 of the fourth embodiment of this invention. The base station 300 stores information 325 included in the door open/close notification signal S515 received from the door 701, into the memory 321. The base station 300 sends the information 325 stored in the memory 321 to the server 100, the reader 400 and the door 701 when needed.

FIG. 25 shows an example of the authentication system of the fourth embodiment of this invention applied to an entry/exit control system. FIG. 25 is a view of the authentication system of the fourth embodiment as seen from the top.

In the application example 709, the reader 400 is installed in the vicinity of the door 701. The reader 400 is bound with the door 701.

In the fourth embodiment, the authentication conditions change according to the open or closed state of the door. For example, if the door 701 is closed then authentication succeeds only in that vicinity (717), and if the door 701 is open then the tag authentication distance is lengthened (718). Tags passing the open end of the door 701 can also be authenticated in this way.

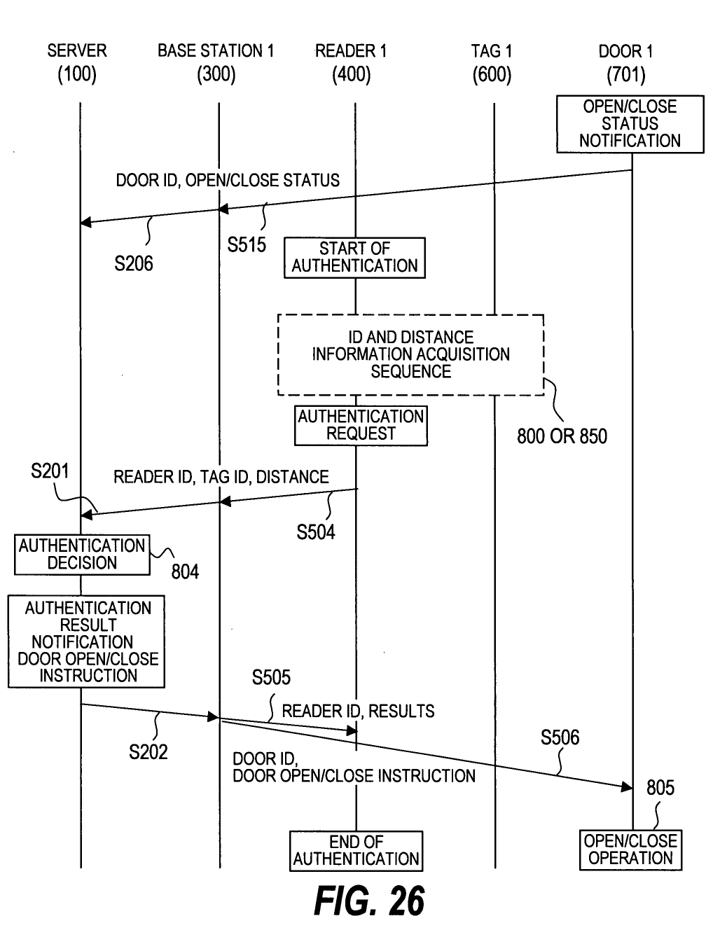

FIG. 26 is a sequence chart for describing one example of the authentication sequence of the fourth embodiment of this invention. An example of authentication is described where the reader 400 acquires the distance information between the tag 600 and the reader 400, and the tag 600 identifier, and the server 100 performs authentication based on the open/close state of the door 701.

The door 701 first of all sends the door open/close notification signal S515 periodically or when there is a change in status. The door open/close notification signal S515 includes the door 701 ID and information on the door status (for example, open/close status, operating status). The server 100 may request the door 701 to send the door open/close notification signal S515.

Next, the base station 300 sends the open/close notification signal S206 including the door open/close notification signal S515 to the server 100. The server 100 finds the door 701 open/close status based on the, received open/close notification signal S206.

The reader 400 executes the ID and distance information acquisition sequence 800, and acquires information on tags around the reader 400. The ID and distance information acquisition sequence 850 (refer to FIG. 8.) may be executed instead of the ID and distance information acquisition sequence 800.

The reader 400 next attaches the reader identifier to the acquired identifier and the distance information, and generates an authentication request signal S504. The reader 400 then sends this generated authentication request signal S504 to the base station 300.

When the authentication request signal S504 is received, the base station 300 sends the authentication request signal S201 to the server 100.

When the authentication request signal S201 is received from the base station 300, the server 100 collates the authentication data 114 with information included in the authentication request signal S201 and the door open/close notification signal S515, and makes an authentication decision (804). For example, when an authentication request is received from the tag 1 (400), then the tag 1 (600) is authenticated (authentication is successful) if the door 701 is open, and the distance between the tag 1 (600) and the reader 1 (400) is less than 90 centimeters. On the other hand, if the door 701 is closed, then authentication succeed if the distance between the tag 1 (600) and the reader 1 (400) is less than 30 centimeters (60 centimeters shorter than when the door 701 is open).

When an authentication request has been received from the reader 3 (491), then authentication is a success if the door 701 is open and the distance between the tag 4 (692) and the reader 3 (491) is less than 90 centimeters, and authentication fails if the door 701 is closed.

Authentication results are subsequently notified to the readers 400 and 490 by way of the base station 300 (S202 and S505) the same as in the first embodiment, and the door 701 instructed to open or close (S506 and 805).

Besides the control state of the control object, the authentication conditions can be changed according to the control contents, the time of day, or the surrounding circumstances. For example, the authentication conditions may be changed by day or night. In the daytime for example, the authentication can be allowed to succeed if the distance between the tag 1 (600) and the reader 1 (400) is less than 90 centimeters, while at night authentication can succeed if less than 30 centimeters.

Authentication conditions may also be changed according to whether a person is inside the room or not. For example, if a person is inside the room, then authentication is allowed to succeed if the distance between the tag 1 (600) and the reader 1 (400) is less than 90 centimeters; and if a person is not in the room then authentication can succeed when less than 30 centimeters. In door unlocking control, when unlocking so that a person within the room can leave the room, authentication can succeed if the distance between the tag 1 (600) and the reader 1 (400) is less than 90 centimeters; and when unlocking so that a person outside the room can enter the room, then authentication can succeed if the distance is less than 30 centimeters.

The control information can be changed by the relation to the distance where the tag is authenticated, to control the control object. During open/close control of the door for example, when authentication succeeds at a distance of less than 60 centimeters between the tag 1 (600) and the reader 1 (400), then the door can be left open for five seconds, and when authentication succeeds at a distance of less than 30 centimeters, then the door may be left open for 10 seconds.

As described before in the fourth embodiment, security and convenience can therefore be upgraded to a still higher level since optimal authentication conditions can be set (for the control state of a control object). Optimal authentication conditions can also be set for the control state of a control object according to other control states of the control object. Namely, security can be given priority, convenience can be given priority to allow building up an authentication system capable of flexibly responding to various circumstances.

### Fifth Embodiment

The fifth embodiment of this invention is described next. The authentication condition for the first embodiment was the distance between the tag and the reader. However, authentication conditions for the fifth embodiment further include information on the combination of multiple tags. Namely, the condition for authentication in the fifth embodiment is changed to the distance where authentication succeeds according to the combination of authentication tags.

The authentication system of the fifth embodiment comprises a server 100, a network 200, a base station 300, an authenticating device (reader) 400, an authentication target device (tag) 600 and 690, and a control object (door) 701. In the fifth embodiment, the configuration of the server 100 is different from those of the first embodiment. Components with the same configuration as the first embodiment are given the same reference numerals and their description is omitted.

The server 100 is connected to the base station 300 by way of the network 200. The base station 300 connects by wireless communication to the reader 400 and the door 701. The reader 400 connects by wireless communication to the tags 600 and 690.

The base station 300 and the door 701 may be connected by wire communication. The door 701 may connect to the reader 400. The door 701 may connect by way of a network 200 to the server 100.

The reader 400 and/or the door 701 may include a base station function. A relay station may be installed between the reader 400 and the base station 300. Multiple base stations, readers, tags and doors may be installed.

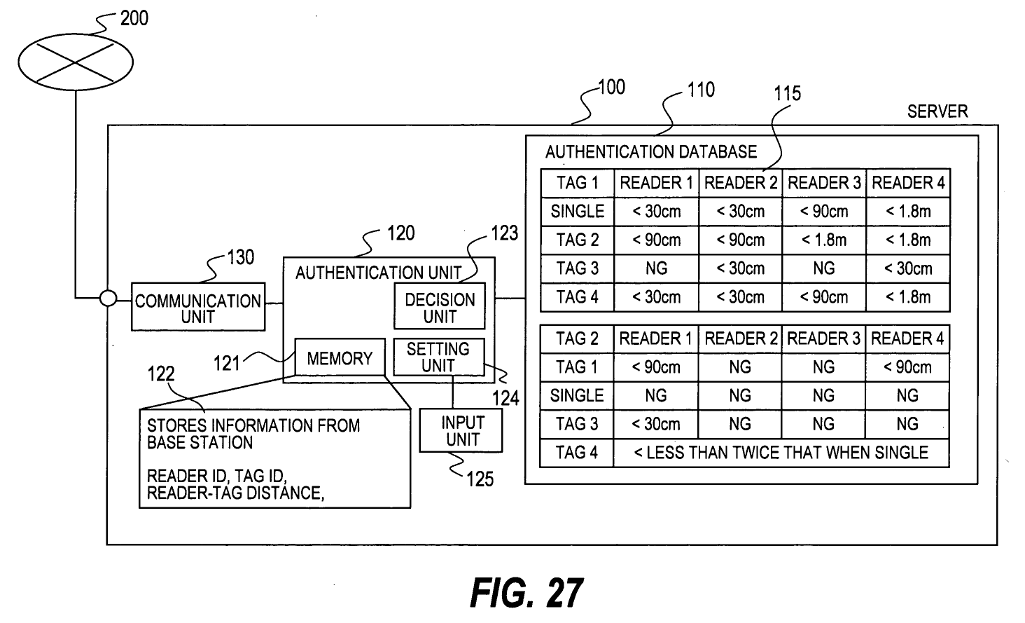

FIG. 27 is a block diagram showing the configuration of the server 100 of the fifth embodiment of this invention. The server 100 stores in the authentication data base 110, an authentication data 115 including distance information between the reader and the tag, the reader identifier and the tag identifier for multiple combinations of the tags.

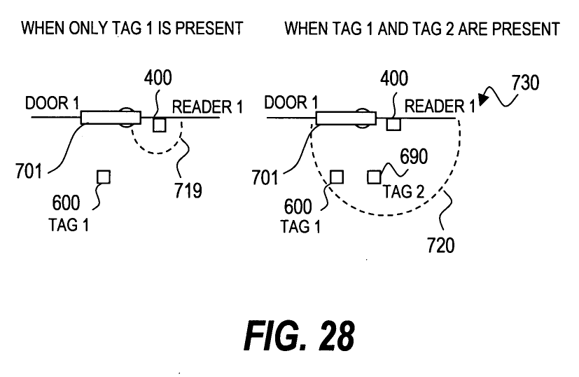

FIG. 28 shows an example of the authentication system of the fifth embodiment of this invention applied to an entry/exit control system. FIG. 28 is a view of the authentication system of the fifth embodiment as seen from the top.

In the application example 730, a reader 400 is installed in the vicinity of the door 701. The reader 400 is bound with the door 701.

In the fifth embodiment, authentication conditions are changed in response to the tag combination in the vicinity of the reader. For example if a single tag 600 has approached the vicinity of the reader 400, then authentication of tag 600 succeeds in the narrow authentication range 719. On the other hand, if both tags 600 and 690 have approached the reader 400, then authentication of tag 600 succeeds in the wide authentication range 720.

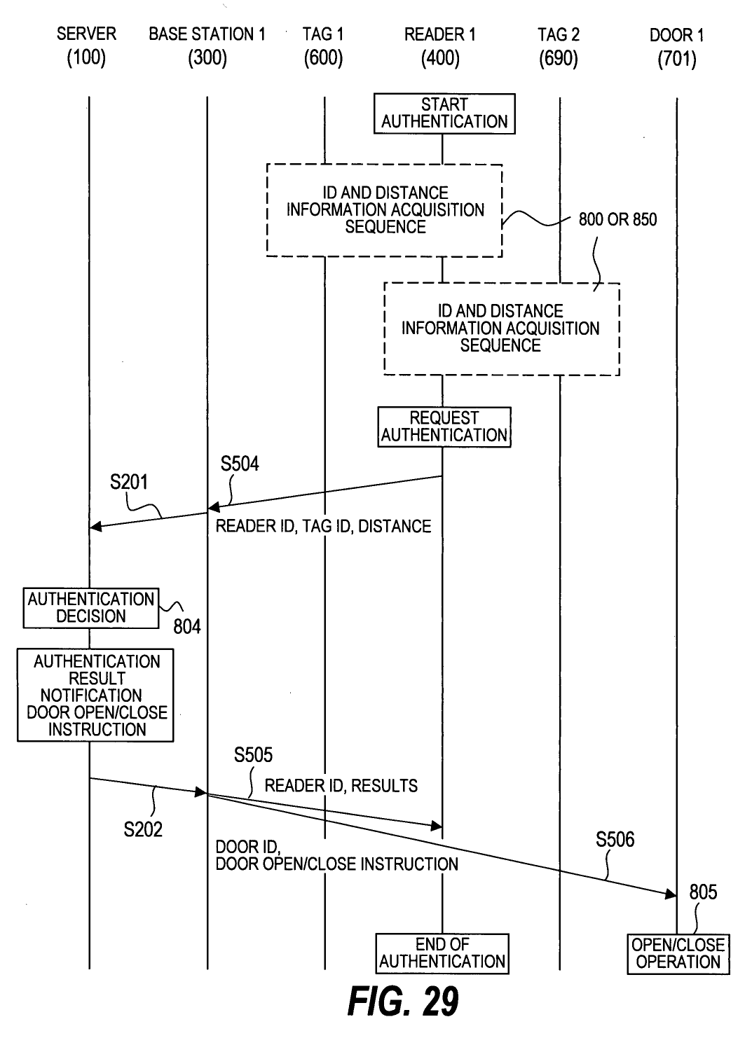

FIG. 29 is a sequence chart for describing an example of the authentication procedure of the fifth embodiment of this invention. The acquisition by the reader 400 of the IDs of the tags 600 and 690, and of distance information between each tag and the reader 400, and the decision by the server 100 to authenticate or not based on the combination of tags is described next.

First of all, the reader 400 executes the ID and distance information acquisition sequence 800, and acquires information on tags around the reader 400. The ID and distance information acquisition sequence 850 (refer to FIG. 8.) may be executed instead of the ID and distance information acquisition sequence 800.

When the reader 400 acquired the tag 600 information and the tag 690 information using the distance information acquisition sequence 800, the reader 400 then sends this acquired information in the authentication request signal S504 and S201 to the server 100 via the base station 300.

When the tag 600 information and the tag 690 information S201 is received from the base station 300, the server 100 accepts an authentication request from the reader 400 for both the tag 600 and the tag 690.

The server 100 then collates the tag 600 authentication conditions where there is a tag 690, and the tag 690 authentication conditions where there is a tag 600, with the information included in respective authentication request signal S201, and makes an authentication decision 804.

If for example there are authentication requests for both the tag 1 (600) and the tag 2 (690), then the reader 1 (400) decides authentication of tag 1 (600) is a success if the distance between tag 1 (600) and the reader 1 (400) is less than 90 centimeters. Also authentication of tag 2 (690) is a success if the distance between tag 2 (690) and the reader 1 (400) is less than 90 centimeters. Authentication is decided a success if authentication of all requested tags (tag 1 (600) and the tag 2 (690)) succeeded. However if authentication of a portion of the tags failed (tag 1 (600) or tag 2 (690)), then authentication of all tags is judged a failure.

If there was an authentication requests for tag 1 (600) from the reader 1 (400) and there was no authentication requests for tag 2 (690), then the “Single” column in the authentication database 115 is referred to, and if the distance between the tag 1 (600) from the reader 1 (400) is less than 30 centimeters then the tag 1 (600) is authenticated.

Also, even if there is an authentication request for both the tag 1 (600) and the tag 2 (690), from the reader 1 (400) if the distance separating tag 2 (690) and the reader 1(400) is then sufficiently large (for example, a distance more than 90 centimeters where authentication cannot be established regardless of tag conditions), then the “Single” column in authentication database 115 is referred to, and the tag 1 (600) authenticated if the distance between the tag 1 (600) and the reader 1 (400) is less than 30 centimeters. In that case, each reader may be set to a distance whose criteria is set in “Single” and stored in the authentication database 115.

The authentication results are notified (S202 and S505) to the readers 400 and 490 via the base station 300 the same as in the first embodiment, and the door 701 is instructed to open/close (S506 and 805).

Therefore in the fifth embodiment as described above, security and convenience can therefore be upgraded to a still higher level since optimal authentication conditions are set according to the combination of multiple tags. For example, if carrying a large package through a door operated by the entry/exit control system applied to this embodiment, then coming into proximity with the reader is impossible but the authentication range can be widened using a combination of two tags.

Also for example, in a room operated by an entry/exit control system to which the present embodiment is applied, separate settings can be made for entry/exit rights and document removal rights, when carrying documents attached with tags stored in that room to an outside location. In other words, the right to carry out confidential documents attached with tags, can be granted to just a portion of the personnel possessing entry/exit rights. Personnel possessing rights to carry out confidential documents attached with tags can be authenticated just for cases where carrying a combination of tags, and allowed to carry those documents outside a restricted area.

### Sixth Embodiment

The sixth embodiment of this invention is described next. The sixth embodiment differs from the first embodiment in including a function to adjust the receiving sensitivity and transmission power of the reader 400.

The authentication system of the sixth embodiment comprises a server 100, a network 200, a base station 300, an authenticating device (reader) 400, an authentication target device (tag) 600, and a control object (door) 701. In the sixth embodiment, the configuration of the base station 300 and the reader 400 are different from those of the first embodiment. Components with the same configuration as the first embodiment are given the same reference numerals and their description is omitted.

The server 100 is connected to the base station 300 by way of the network 200. The base station 300 connects by wireless communication to the reader 400 and the door 701. The reader 400 connects by wireless communication to the tag 600.

The base station 300 and the door 701 may be connected by wire communication.

The door 701 may connect to the reader 400. The door 701 may connect by way of a network 200 to the server 100.

The reader 400 and/or the door 701 may include a base station function. A relay station may be installed between the reader 400 and the base station 300. Multiple base stations, readers, tags and doors may be installed.

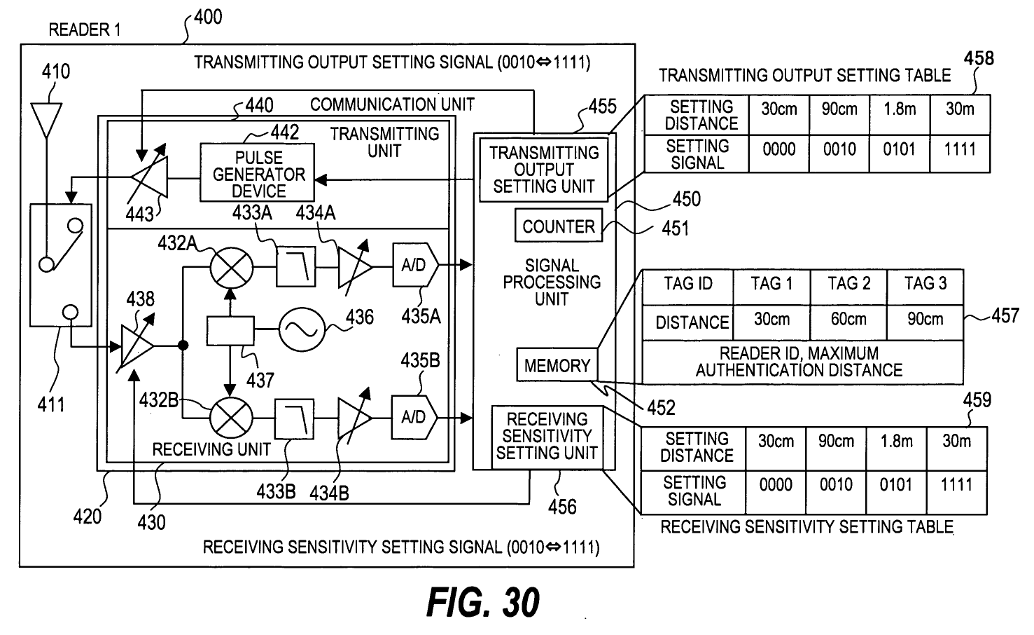

FIG. 30 is a block diagram showing the configuration of the reader 400 of the sixth embodiment of this invention. The wireless receiving unit 430 for the reader 400 of the sixth embodiment comprises a variable gain low noise amplifier 438, mixers 432A and 432B, low pass filters 433A and 433B, variable gain amplifiers 434A and 434B, analog to digital converters 435A and 435B, a local oscillator 436, and a phase shifter 437. The wireless transmitting unit 440 comprises a variable gain power amplifier 443 and a pulse generator 442. The signal processing unit 450 comprises a counter 451, a memory 452, a transmission power setting unit 455 and a receiving sensitivity setting unit 456.

When the maximum authentication distance setting signal S516 is received, the reader 400 stores information 457 on the maximum authentication distance that was received in the memory 452. The transmission power setting unit 455 then sets the gain on the variable gain power amplifier 443 based on the transmission power setting table 458 and the information 457 stored in the memory 452. The receiving sensitivity setting unit 456 sets the gain of the variable gain low noise amplifier 438 based on the receiving sensitivity setting table 459 and the information 457 stored in the memory 452.

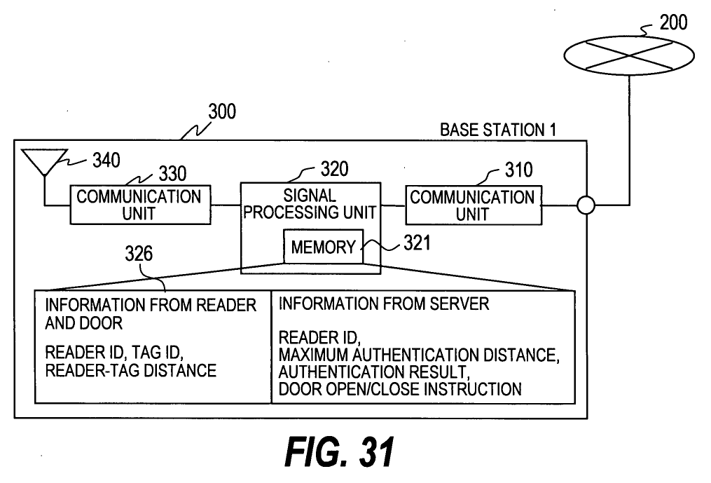

FIG. 31 is a block diagram showing the configuration of the base station 300 of the sixth embodiment of this invention. The base station 300 stores the information 326 included in the maximum authentication distance setting signal S207 received from the server 100 in the memory 321. The base station 300 sends the information 326 stored in the memory 321 to the server 100, the reader 400 and the door 701 as needed.

The authentication sequence for setting the maximum authentication distance in the sixth embodiment of this invention is described next utilizing the sequence chart.

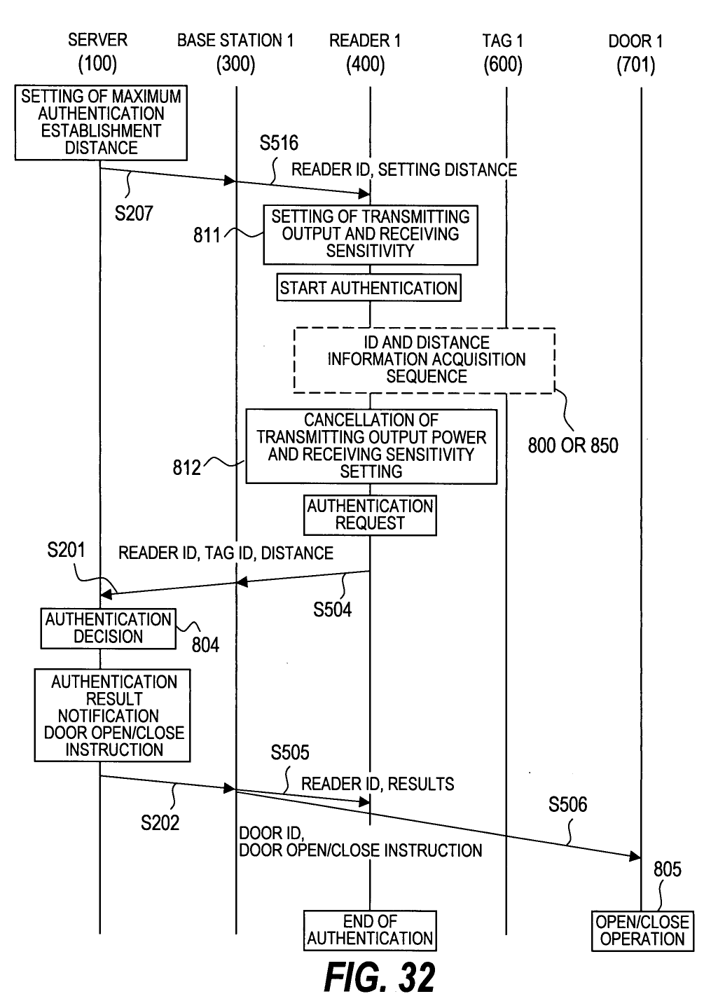

FIG. 32 is a sequence chart for describing an example of the authentication sequence of the sixth embodiment of this invention. An example is described for the server 100 setting the maximum authentication distance of the reader 400, and the reader 400 acquiring distance information between the tag 600 and the reader 400, and the tag 600 identifier.

First of all, the server 100 calculates the maximum authentication distance information for each reader, based on the authentication database 110, and sends the maximum authentication distance setting signal S207. The maximum authentication distance as specified in the authentication data 111, is 90 centimeters for reader 400, 30 centimeters for the reader 490, 90 centimeters for the reader 491, and 1.8 meters for the reader 492. The maximum authentication distance setting signal S207 includes information on the maximum authentication distance and the reader ID.

When the base station 300 receives the maximum authentication distance setting signal S207, it stores the information included in the maximum authentication distance setting signal S207 into the memory 321. The base station 300 then sends the maximum authentication distance setting signal S516 to each reader based on the information 326 stored in the memory 321.

When the maximum authentication distance setting signal S516 is received from the base station 300, the reader 400 sets the transmission power and the receiving sensitivity (811) according to the maximum authentication distance setting signal S516 that was received. When setting the transmission distance to 90 centimeters according to the transmission power setting table 458, the transmission power setting unit 455 outputs a four bit setting signal of “0010” to the variable gain power amplifier 443. When setting the reception distance to 90 centimeters according to the receiving sensitivity setting table 459, the receiving sensitivity setting unit 456 outputs a setting signal of “0010” to the variable gain low noise amplifier 438.

After the reader 400 sets the transmission power and receiving sensitivity, it executes the ID and distance information acquisition sequence 800. The reader 400 executes the ID and distance information acquisition sequence 800 multiple times and acquires information on tags present in the range of transmission/reception from the reader 400. The ID and distance information acquisition sequence 850 (refer to FIG. 8.) may be executed instead of the ID and distance information acquisition sequence 800.

The reader 400 afterwards cancels the transmission power and receiving sensitivity settings (812). When set to a maximum transmission range according to the transmission power setting table 458, the transmission power setting unit 455 outputs a 4 bit setting signal of “1111” to the variable gain power amplifier 443. Also, when set to a maximum receiving distance according to the receiving sensitivity setting table 459, the receiving sensitivity setting unit 456 outputs a setting signal of ” 1111” to the variable gain low noise amplifier 438.

After canceling the transmission power and receiving sensitivity settings, the reader 400 sends an authentication request signal S504 to the server 100 by way of the base station 300 (S201).

When the authentication request signal S201 is received, the server 100 collates the information included in the authentication request signal S201 with the authentication data 111, and makes an authentication decision (804).

The authentication results are then notified (S202 and S505) to the readers 400 and 490 by way of the base station 300, the same as in the first embodiment, and the door 701 is instructed to open/close (S506 and 805).

The signal for setting the transmission power and receiving sensitivity need not always be a 4 bit signal.

Besides the method for setting the transmission power, by setting the gain of the variable gain power amplifier 443, an attenuator may be inserted in an internal section or an external section of the wireless transmitting unit 440. The antenna 410 may also be switched to a low gain antenna. However, the gain setting on the variable gain power amplifier 443 is optimal so there is no need to install a new antenna or attenuator.

Besides the method for setting the receiving sensitivity by setting the gain on the variable gain low noise amplifier 438, an attenuator may be inserted in an internal section or an external section of the wireless receiving unit 430. The antenna 410 may also be switched to a low gain antenna. However the variable gain low noise amplifier 438 is preferably set to an optimal gain so there is no need to install a new antenna or attenuator.

The transmission power and receiving sensitivity may be set when starting the system but may be set just one when making the initial settings when constructing the system. The transmission power and receiving sensitivity settings may also be set periodically. If setting the transmission power and receiving sensitivity periodically, then these settings may be changed according to the control state of the control object and/or the date-time.

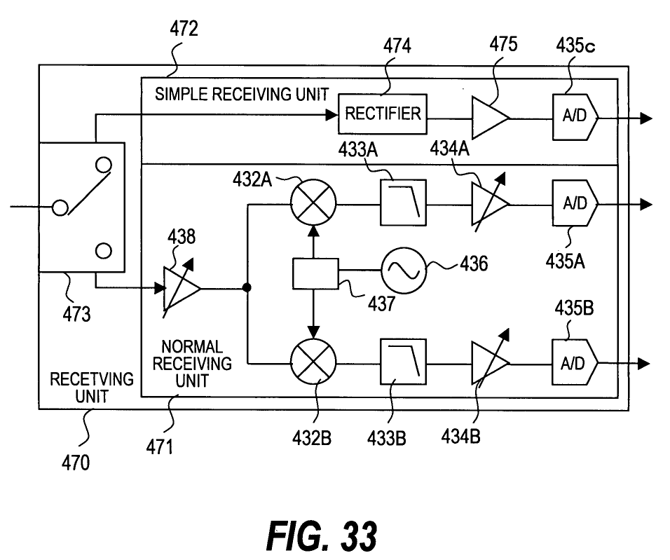

Moreover, if a rough receiving sensitivity is permissible then the method shown in FIG. 33 is preferable for reducing the power consumption.

FIG. 33 is a block diagram showing the configuration of the receiving unit 470 of the reader 400 of the sixth embodiment of this invention.

The reader 400 comprises a wireless receiver unit 470 as shown in FIG. 33 instead of the wireless receiving unit 430 shown in FIG. 30.

The wireless receiving unit 470 comprises a first receiving unit 471, a second receiving unit 472, and a switch 473. The first receiving unit 471 possesses the same configuration as the wireless receiving unit 430 shown in FIG. 30. The second receiving unit 472 is a simple receiver and comprises a rectifier 474 that is a component such as diode, an amplifier 475 and an analog to digital converter 435C.

The method for switching the receiving sensitivity utilizing the wireless receiving unit 470 is described next. The switch 473 is selected so as to receive a signal in the first receiving unit 471 before making the transmission power and the reception sensitivity setting 811. In this transmission power and the reception sensitivity setting 811, the switch 473 is selected in order for the second receiving unit 472 to receive the signal. The second receiving unit 472 is designed for a lower receiving sensitivity than the first receiving unit 471. In the transmission power and receiving sensitivity cancel settings 812, the switch 473 is selected so that the first receiving unit 471 receives the signal.

In the sixth embodiment as described above, the reader 400 does not communicate with tags at locations farther away than the maximum authentication distance whose authorization is not needed. The number of ID and distance information acquisition sequence 800 attempts can therefore be reduced, and the time required for authentication can be shortened. The authentication processing speed can in this way be improved and the convenience improved to a still higher level.

The ID and distance information acquisition sequence 800 trial attempt count can also be reduced, and the information volume of the authorization request signal decreased so that power consumption of the reader and the tag is reduced. The size of the batteries mounted in the reader and tag can be made smaller, moreover the batteries have a longer operating time so that convenience can be improved to a yet higher level.

The ID and distance information acquisition sequence 800 is only performed at a close range so that emission of unnecessary radio waves is suppressed, and the risk of exposure to unauthorized access from far away locations is reduced. The security is in this way improved to a still higher level.

While the present invention has been described in detail and pictorially in the accompanying drawings, the present invention is not limited to such detail but covers various obvious modifications and equivalent arrangements, which fall within the purview of the appended claims.

What is claimed is:

1. An authentication system comprising an authenticating device and an authentication target device which communicates by using ultra wide band impulse signals,
wherein the authentication system measures the distance between the authenticating device and the authentication target device by using ultra wide band impulse signal to exchange identification information of the authenticating device and identification information of the authentication target device between each device,
wherein the authenticating device authenticates the authentication target device based on a combination of the measured distance between the authenticating device and the authentication target device, and the exchanged identification information of the authentication target device, and
wherein the authenticating device generate control signal to control a control target based on the authentication results.

2. The authentication system according to claim 1,
wherein the authentication system measures the distance between the authenticating device and the authentication target device using ultra wide band impulse signal, simultaneously with exchanging identification information between the authenticating device and the authentication target device.

3. An authentication system comprising at least one authentication target device which has a unique identifier, an authenticating device which authenticates the authentication target device based on stored authentication condition, and a control target device controlled based on authentication results,
wherein the authenticating device stores the authentication condition including a first distance information on the distance between the authenticating device and the authentication target device, and an identifier of the authentication target device, the first distance information being defined corresponding to the identifier of the authentication target device,
wherein the authentication system measures the distance between the authenticating device and the authentication target device by using signal to exchange an identifier of the authenticating device and the identifier of the authentication target device between each device,
wherein the authenticating device authenticates the authentication target device based on a combination of the first distance information and the identifier of the authentication target device, and
wherein the authenticating device controls the control target device based on the authentication results.

4. The authentication system according to claim 3,
wherein the authentication system measures the distance between the authenticating device and the authentication target device using the signal to exchange the identifier of the authenticating device and the identifier of the authentication target device, simultaneously with exchanging identification information between the authenticating device and the authentication target device.

5. The authentication system according to claim 3,
wherein the authentication condition further includes information on the direction where the authentication target device is present,
wherein the authenticating device obtains the direction of the authentication target device from the authenticating device by using the signal to exchange the identifier of the authenticating device and the identifier of the authentication target device between each device, and
wherein the authenticating device authenticates the authentication target device based on a combination of the direction information, the first distance information and the identifier of the authentication target device.

6. The authentication system according to claim 3,
wherein the authentication condition further includes a second distance information on distances between multiple authenticating devices,
wherein the first distance information is defined to correspond to the second distance information, and
wherein the authenticating device authenticates the authentication target device based on a relation between the first distance information and the identifier of the device.

7. The authentication system according to claim 3,
wherein the first distance information includes information on a distance between the authentication target device and the multiple authenticating devices, and
wherein the authenticating device authenticates the authentication target device based on a combination of the first distance information and the identifier of the authentication target device.

8. The authentication system according to claim 3,
wherein the authentication condition further includes information on a status of the control target device,
wherein the first distance information is defined to correspond to the status information on the control target device, and
wherein the authenticating device authenticates the authentication target device based on a combination of the first distance information, the status information on the control target device, and the identifier of the authentication target device.

9. The authentication system according to claim 3,
wherein the authentication condition further includes information on a control content of the control target device,
wherein the first distance information is defined to correspond to the control content information, and
wherein the authenticating device authenticates the authentication target device based on a combination of the first distance information, the control content information, and the identifier of the authentication target device.

10. The authentication system according to claim 3,
wherein the authentication condition further includes at least one of date and time at which the authenticating devices performs authentication,
wherein the first distance information is defined to correspond to at least one of the date and the time included in the authentication condition, and
wherein the authenticating device authenticates the authentication target device based on a combination of the first distance information, at least one of the date and the time, and the identifier of the authentication target device.

11. The authentication system according to claim 3,
wherein the authentication condition further includes information on a pair of the plurality of simultaneously authenticated authentication target devices,
wherein the first distance information is defined to correspond to the pair information, and
wherein the authenticating device authenticates the authentication target device based on a combination of the first distance information, the pair information, and the identifier of the authentication target device.

12. The authentication system according to claim 3,
wherein the authenticating device comprises a transmitting unit for sending the signal to exchange identifier with the authentication target devices,
wherein the transmitting unit comprises a transmission output adjustment unit for adjusting the transmission power of the signal to exchange the identifier of the authentication target devices and the identifier of the authenticating device, and
wherein the transmission power adjustment unit controls the output power of the signal in accordance with the range for authenticating the authentication target device.

13. The authentication system according to claim 3,
wherein the authenticating device comprises a receiving unit for receiving the signal to exchange identifier with the authentication target devices,
wherein the receiving unit comprises a receiving sensitivity adjustment unit for adjusting the receiving sensitivity of the signal to exchange the identifier of the authentication target devices and the identifier of the authenticating device, and
wherein the receiving sensitivity adjustment unit controls the receiving sensitivity of the signal in accordance with the range for authenticating the authentication target device.

14. The authentication system according to claim 3,
wherein the signal to exchange the identifier of the authenticating device and the identifier of the authentication target devices is ultra wide band impulse signal.
